(19) United States
(12) Patent Application Publication
(10) Pub. No.: US 2017/0034659 A1
(43) Pub. Date: Feb. 2, 2017

(54) Mobile Social Activity Networking Systems and Methods

(71) Applicant: Y R Tech, LLC, Fort Worth, TX (US)

(72) Inventors: Jonathan Joseph Shnitzer, Fort Worth, TX (US); Ricardo Barreda, III, Fort Worth, TX (US)

(21) Appl. No.: 15/223,945

(22) Filed: Jul. 29, 2016

Related U.S. Application Data
(63) Continuation-in-part of application No. 14/827,938, filed on Aug. 17, 2015.
(60) Provisional application No. 62/079,149, filed on Nov. 13, 2014.

(51) Int. Cl. H04W 4/02; G06F 17/30

(52) U.S. Cl. CPC H04W 4/023; G06F 17/30241; H04L 67/42

(57) ABSTRACT

A mobile social activity networking system configured for facilitating event planning and coordination of activities of users is provided. The system allows users to input user preferences on a mobile computing device via a social networking application on the mobile computing device; to form a group of users with preferred activities and geographic range of proximity to the group; and to select a location for the group of users. The system retrieves data comprising group preferences from a server, retrieves GPS coordinates of mobile computing devices in communication with the system, determines relative locations of mobile computing devices using the retrieved GPS coordinates, and determines an overlap of a user-supplied geographic range and the preferred group geographic range from the selected location based on data representing relative locations of the mobile computing devices and data representing the preferred group geographic range of proximity.

### CROSS REFERENCE TO RELATED APPLICATIONS

This application claims priority to nonprovisional patent application Ser. No. 14/827,938, which claims priority to provisional patent application No. 62/079,149, filed Nov. 13, 2014.

### FIELD OF THE INVENTION

The present invention generally relates to mobile social networking, and more particularly relates to mobile applications software and systems that match users based on specific activity interests within a user-selected geographic distance with a global positioning system.

### DESCRIPTION OF THE RELATED ART

Social networking has become a significant aspect of many people's lives as they communicate with others who are members of the same social networking applications. In many instances, members who have joined these social networks to find other individuals with similar interests but may be unaware that every day they are passing hundreds of people some of who may also have these same interests.

Social networks may often specify three levels of social connections. These may include immediate family and close friends, extended friends, and “shared interest” groups. Today users interact sporadically, but intensely, with extended friends and extended friends through games, avatars, and general updates and information. Users with common interests also may communicate in ways that extend into business. The popularity of social networking in business, for trading, online collaboration, and virtual meetings continues to grow. With the ubiquity of “mobile apps”, more heretofore unrealized social connections may now be possible.

### BRIEF SUMMARY

The invention herein disclosed and described provides a solution to the shortcomings in prior art in social networking, and achieves the above noted goals through the provision of a mobile social activity networking system configured for facilitating event planning and coordination of activities of users.

In accordance with an exemplary embodiment of the present invention, a mobile social activity networking system configured for facilitating event planning and coordination of activities of users is provided. The system is configured to enable a system user to input user preferences on a mobile computing device via a downloaded social networking application on the mobile computing device, the user preferences including preferred activities of the user, a preferred geographic range of proximity to the user of other users that the user wants to communicate with; form a group of users, the group having group members comprised of system users, the group enabled to specify data comprising group preferences including preferred activities of the group, a preferred group geographic range of proximity to the group to the other users of the system that the group wants to communicate with; select a location for the group of users, by providing a street address or by dropping a marker onto a location on a map displayed on a user interface of the mobile computing device. The system retrieves data comprising group preferences from a server, the system retrieves GPS coordinates of mobile computing devices in communication with the system, the system determines relative locations of mobile computing devices using the retrieved GPS coordinates, the system determines an overlap of a user-supplied geographic range and the preferred group geographic range from the selected location based on data representing relative locations of the mobile computing devices and data representing the preferred group geographic range of proximity.

Optionally, when the user travels to a new location, the system determines the user's location using the global positioning system receiver of the mobile computing device of the user, the system automatically uses the user's input geographic preferences to determine a new overlap of a new user-defined geographic range and a new group geographic range retrieved by the system.

Optionally, when the user travels to a new location, the system determines the user's location using the global positioning system receiver of the mobile computing device of the user, the system retrieves data representing user-subscribed events associated with the group, the system receives user input data associated with the user-subscribed events, and the system transmits the user input data to the server associated with the group to update the data representing the user-subscribed events.

Optionally, the system is configured to maintain pending lists associated with the user-subscribed events, the pending lists comprising users that traveled to new locations, and the system transmits data comprising group information to the user.

Optionally, the system is further configured to retrieve the data comprising the group preferences from the associated server; and filter data comprising group information based on the data comprising the group preferences, on informational data related to the user, and on geographic data related to the user.

Optionally, the mobile social activity networking system is configured to automatically transmit messages including event invitations and event updates to members of the group, wherein members are users who are subscribed to the group.

With respect to the above description, before explaining at least one preferred embodiment of the herein disclosed invention in detail, it is to be understood that the invention is not limited in its application to the details of construction and to the arrangement of the components in the following description or illustrated in the drawings. The invention herein described is capable of other embodiments and of being practiced and carried out in various ways which will be obvious to those skilled in the art. Also, it is to be understood that the phraseology and terminology employed herein are for the purpose of description and should not be regarded as limiting.

As such, those skilled in the art will appreciate that the concept upon which this disclosure is based may readily be utilized as a basis for designing other structures, methods and systems for carrying out several purposes of the present disclosed device. It is important, therefore, that the claims be regarded as including such equivalent construction and methodology insofar as they do not depart from the spirit and scope of the present invention.

### BRIEF DESCRIPTION OF THE DRAWINGS

An understanding of the advantages provided by the invention may be facilitated by reference to the following detailed description of exemplary embodiments together with the accompanying drawings wherein:

FIG. 1 illustrates an activity networking system according to an exemplary embodiment of the present invention.

FIG. 2 illustrates a global positioning system in an activity networking system according to an exemplary embodiment of the present invention.

FIG. 3 illustrates another global positioning system in an activity networking system according to an exemplary embodiment of the present invention.

FIG. 4 illustrates an activity networking connection flowchart method according to an exemplary embodiment of the present invention.

FIG. 5 illustrates an activity networking system settings menu according to an exemplary embodiment of the present invention.

FIG. 6 illustrates an activity networking system activities selection menu according to an exemplary embodiment of the present invention.

FIG. 7 illustrates an activity networking system activities selection menu with icons according to an exemplary embodiment of the present invention.

FIG. 8 illustrates an activity networking system activities selection menu with proficiency levels according to an exemplary embodiment of the present invention.

FIG. 9 shows matched profiles of users according to an exemplary embodiment of the present invention.

FIG. 10 shows selection or rejection of matched profiles of users by swiping according to an exemplary embodiment of the present invention.

FIG. 11 shows complete profile of a matched profile of a user according to an exemplary embodiment of the present invention.

FIG. 12 illustrates an activity networking invitation flowchart method describing an exemplary embodiment of the present invention.

FIG. 13 illustrates an activity networking messaging flowchart method describing an exemplary embodiment of the present invention.

FIG. 14 illustrates an activity networking system messaging menu according to an exemplary embodiment of the present invention.

FIG. 15 illustrates an activity networking system messages display according to an exemplary embodiment of the present invention.

FIG. 16 illustrates an activity group networking flowchart method describing an exemplary embodiment of the present invention.

FIG. 17 illustrates an activity networking system “Go Active” menu according to an exemplary embodiment of the present invention.

FIG. 18 illustrates an activity networking system “Go Active” screen according to an exemplary embodiment of the present invention.

FIG. 19 illustrates a user dating flowchart method describing an exemplary embodiment of the present invention.

FIG. 20 illustrates a user snap reporting flowchart method describing an exemplary embodiment of the present invention.

FIG. 21 illustrates an activity networking system with third party servers for groups of users according to an exemplary embodiment of the present invention.

FIG. 22 illustrates an activity networking system group category selection menu according to an exemplary embodiment of the present invention.

FIG. 23 illustrates an activity networking system group selection menu according to an exemplary embodiment of the present invention.

FIG. 24 illustrates an activity networking system group profile screen according to an exemplary embodiment of the present invention.

FIG. 25 illustrates an activity networking system group promotions screen according to an exemplary embodiment of the present invention.

FIG. 26 illustrates an activity networking system with group-related third party retail promotion according to an exemplary embodiment of the present invention.

FIG. 27 illustrates an activity networking system group-related third party locations according to an exemplary embodiment of the present invention.

### DETAILED DESCRIPTION OF THE EXEMPLARY EMBODIMENTS

While the technology disclosed herein is susceptible of embodiment in many different forms, there is shown in the drawings, and will herein be described in detail, at least some of the exemplary embodiments, with the understanding that this description is to be considered as an exemplification of the principles and does not limit the broad aspects of the inventions, which are only defined by the patent claims.

The numerous innovative teachings of the present application will be described as advantageously applied to the particular problems of a pre-loader graphic display system and method. However, it should be understood that the disclosed embodiments are only exemplary and do not limit the many advantageous uses of the innovative teachings herein. In general, statements made in the specification of the present application do not limit any of the various claimed inventions unless so specified. Moreover, some statements may apply to some inventive features but not to others.

### DEFICIENCIES IN THE PRIOR ART

A need has now been identified for social networking between unrelated people, who do not know each other at the outset, but reside (or are in transit, or at a travel destination or stop) within a range of distance of each other (such as for example, within a common neighborhood, city, or within a few miles range for ease of travel to meet up, etc.), and who share common interests such as sports, training, concerts, etc. to communicate, meet and conduct social activity through use of a common mobile device application.
Prior art systems do not generally provide for connecting geographically proximal users (i.e. those within a user specified distance from the user) based on activity interests and proficiency.
Prior art systems generally do not provide a messaging and invitation method to connect geographically proximal users based on activity interests and proficiency.
Prior art systems generally do not provide a method for group activity networking to initiate, broadcast and conduct a group event based on activity interests.
Prior art systems generally do not provide a method for travelling users to perform matching networking activities at the travelled place.
Prior art systems do not generally provide a system/method to report inappropriate content with a screenshot.
Prior art systems do not generally provide a method for networking users with interests in rare/uncommon activities and sports.

While some of the prior art may teach some solutions to some of these problems, the prior art does not address the connecting of users that are strangers to each other based on activity and distance criteria via software and a mobile computing device, such as a smartphone.

### EXEMPLARY OBJECTIVES OF THE TECHNOLOGY

Accordingly, the objectives of the technology are (among others) to:
Provide for connecting geographically proximal users (i.e. those within a user specified distance from the user) based on user specified activity interests and proficiency.
Provide a messaging and invitation method to connect geographically proximal users based on activity interests and proficiency.
Provide a group activity networking via a communications application configured on a mobile device to initiate, broadcast and conduct a group event based on activity interests.
Provide a method for travelling users to perform matching networking activities at the destination of their travel activity.
Provide a system/method to report inappropriate content, for example, with a screenshot.
Provide a method for networking users with interests in rare/uncommon activities and sports.

While these objectives should not be understood to limit the teachings of the present invention, in general these objectives are achieved in part or in whole by the disclosed exemplary embodiments that are discussed in the following sections. One skilled in the art will no doubt be able to select aspects of the present exemplary embodiment as disclosed to effect any combination of the objectives described above.

### An Exemplary Embodiment Mobile Social Activity Networking System Diagram (0100)

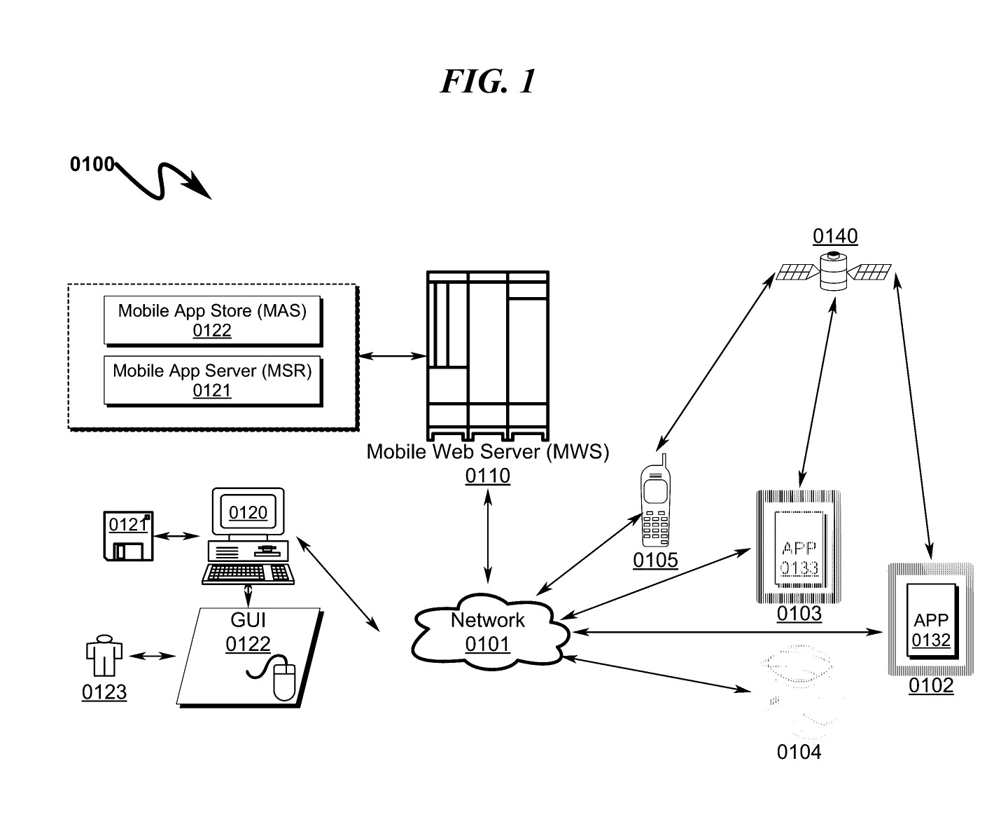

An example of the present inventive technology may be seen in more detail as generally illustrated in FIG. 1 (0100), wherein plural mobile computing devices (0102, 0103), wireless devices (0105), smart watch (0104) are connected to a network (0101). The network (0101) may include a wired protocol such as Ethernet or wireless protocol such as 3G, 4G, WIFI, NFC, WLAN, and LTE. A MWS (0110) is configured to connect to a network connecting plural mobile computing devices (MCDs) (0102, 0103, 0104, 0105) to a mobile application server (MSR) (0121). A user computing device (UCD) (0120) connects to the MWS (0110) to enable a user to access the MSR (0121).

The UCDs (0120) is/are configured for enabling users such as web site administrators, mobile application developers to interact with the MWS (0110) and the MSR (0121). The UCDs (0320) may further comprise a microprocessor executing instructions read from a computer-readable medium (0121) and a graphical user interface (GUI) (0122) with a pointing device. The users may open the GUI (0122) and upload mobile activity networking application (ANA) to the MAS (0122). The administrators may receive requests through the UCD (0120) or manually. Subsequently, they may process and upload updates to the MSR (0121).

The MCDs are equipped with global positioning devices to connect to a global positioning system (GPS) (0140). The GPS (0140) keeps tracks of the MCDs (0102, 0103, 0104, 0105) location which is used to determine distances between multiple MCDs. According to an exemplary embodiment, the ability to determine a distance and report back to the activity networking application on the MCDs (0102, 0103, 0104, 0105) enables the mobile social-activity networking application to match users based on the distance. The users are system-matched by the social networking activity application in real time based on the user input preferences. The activity-based social networking application may further facilitate event planning and coordinate activities between the system-matched users of the system. The user preferences may include demographic data defining other users the user wants to interact with, preferred activities the user wants to engage in, the preferred geographic range of proximity to the user of other users the user wants to communicate with.

### Mobile Application Server (MSR) (0121)

Mobile application server (0121) refers to a server that hosts, installs, and operates mobile applications and other services. The mobile application server may contain both a server operating system and server hardware. These function simultaneously to allow the server to provide remote access and services to apps, which can include authentication, updates, and security features. In this system, the mobile application server (0121) communicates with the client component, which operates on the mobile device (MCD) to receive apps, download updates, and follows the commands of the server. All of these functions occur over the network (0101). This allows the administrator of the system to configure app settings, send out updates, and wipe all data from a remote location.

In a mobile application server, the key features may include user management, data redundancy, security of the application and data, high levels of availability, a centralized interface for management, and load balancing. The MSR (0121) may be connected to a mobile application store (MAS) (0122) that stores plurality of mobile applications. A user may request to download or update an application through the MWS (0110). According to an exemplary embodiment application administrators may receive inappropriate content reports from users and act accordingly upon verification by an embedded code in a provided screen snapshot.

### Exemplary Embodiment Global Positioning System Block Diagram (0200-0300)

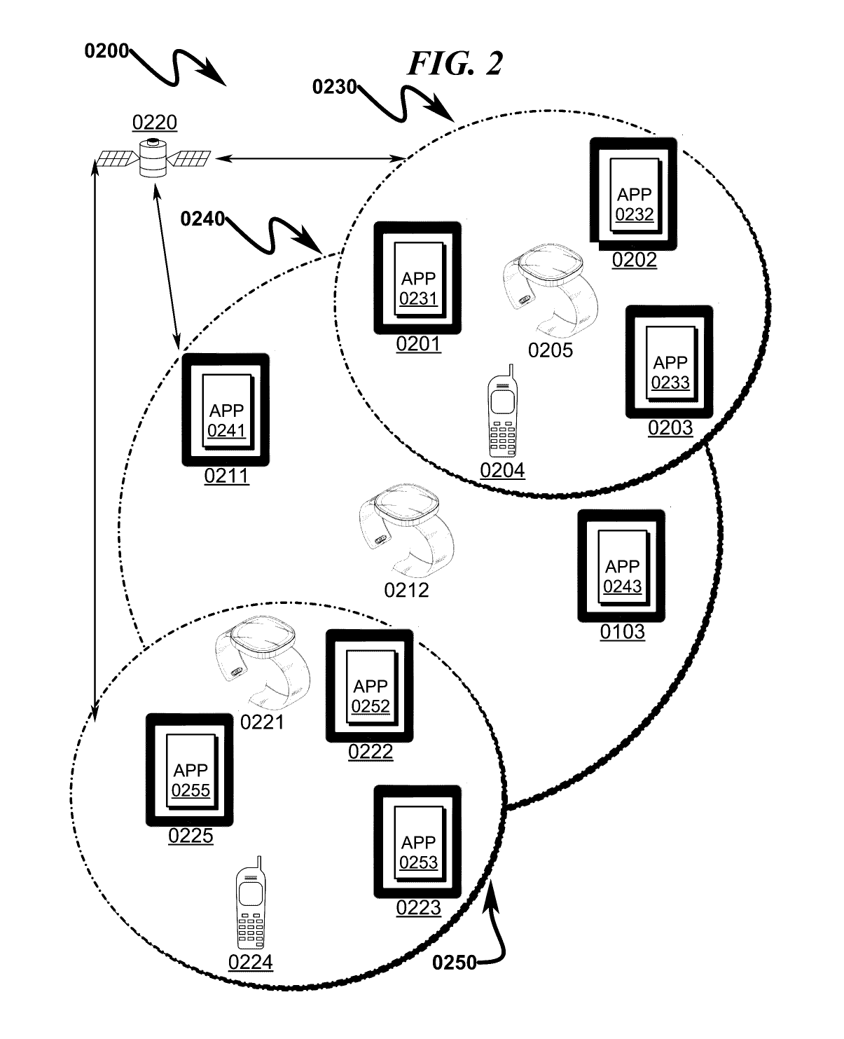

As generally illustrated in FIG. 2 (0200), users carrying plural mobile computing devices are physically located within separate distance circles (0230, 0240, 0250). The mobile devices are enabled with global positioning devices that connect to a global positioning system for keeping track of the location of the mobile devices. Based on a given location, a distance is calculated by the activity-based social networking application (ANA) of all the other devices (mobile computing devices). The calculated distance is further used to determine all available users within a certain circle. For example circle (0230) may comprise plural users with MCDs (0201, 0202, 0203, 0204). Similarly circle (0240) may comprise plural users with MCDs (0211, 0212, 0203, 0221, 0204, 0201) and likewise circle (0230) may comprise plural users with MCDs (0201, 0202, 0203, 0204). A user with MCD (0212) may set a larger distance than user with MCD (0205). Hence, the user with MCD (0212) may have a larger user base to connect and perform activities. Users constrained with distance may opt to set smaller distance in the setting menu and may have to wait longer time to find a match or switch activities to match with other users in the distance circle.

A travelling user may also use the application to set up a distance when travelling to a new place. The user may connect with other users based on a lodging location and an activity preference. The distance circle associated with the user is recalculated based on the travelling location. According to an exemplary embodiment, the application enables the user to recalculate distance/proximity circles and search for matching profiles. For example, a user travelling to a location may prefer to play tennis and set a preferred distance of 10 miles. Since it involves playing with a partner, the user may set the distance and preset tennis as an activity with proficiency level on the mobile activity networking application. The user may use standardized USTA tennis ratings such as 3.0, 3.5 or 4.0. Upon initiating a search with the activity networking application, users within 10 miles with a tennis interest and similar rating display on the user's activity application. The user may select a user based on the profile and other criteria. The user may message or invite the matched user for playing tennis upon agreeing on a location and time.

According to an exemplary embodiment, the activity application enables a travelling user to search for users with similar/matching activity interests (user preferences) within a certain distance of his location, which is readily ascertained by GPS, and communicated to the social activity networking application and the system.

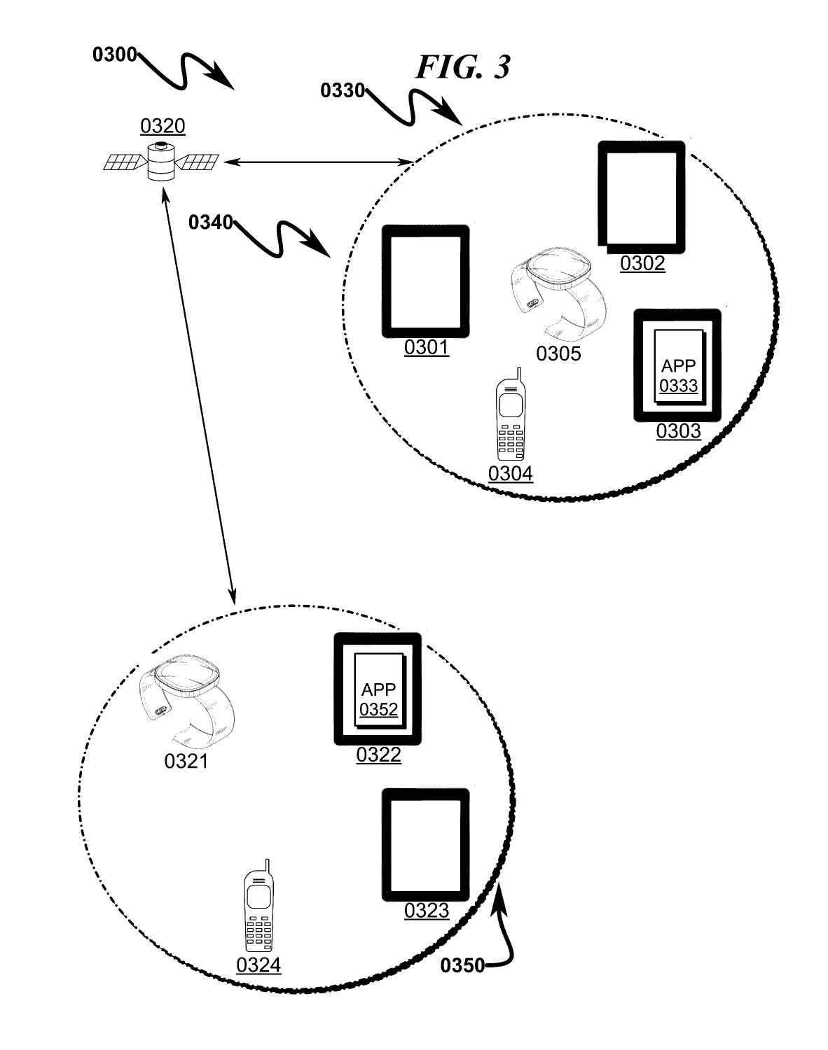

As generally illustrated in FIG. 3 (0300), users carrying plural mobile computing devices are physically located within separate distance circles (0330, 0350). The mobile devices are enabled with global positioning devices that connect to a global positioning system for keeping track of the location of the mobile devices. According to an exemplary embodiment, with the activity-based social networking application a user may search for users with similar/matching activity interests within a certain radius of distance, within the circle, for example. Thus, for example, the user (0321) may pre-select a distance that enables the ANA to search within distance circle (0350).

### Exemplary Embodiment Social Activity Networking Connection Method (0400)

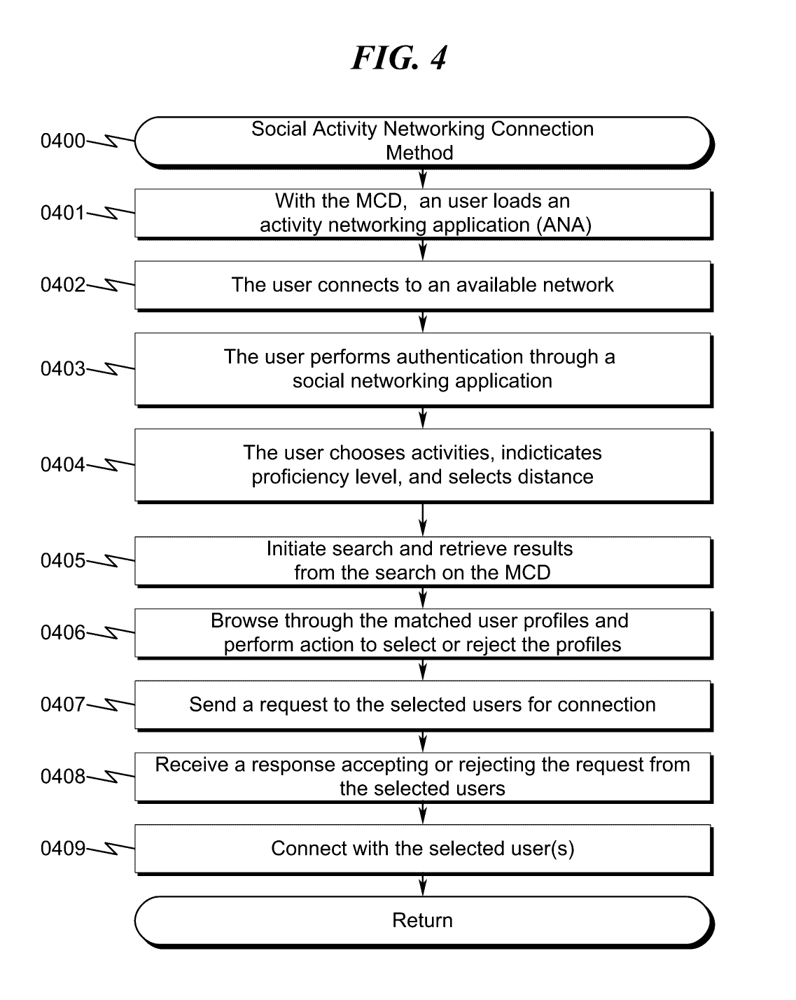

As generally seen in the flow chart of FIG. 4 (0400), the example of the present social activity networking connection methods may be described in terms of the following steps:
(1) with the MCD, connecting to a network (0401);
(2) loading an activity-based social networking application into the MCD (0402);
(3) authenticating through a social networking application (0403);
(4) choosing activities indicating proficiency level and selecting distance to search (0404);
The user preferences may include demographic data defining other users the user wants to interact with, preferred activities the user wants to engage in, the preferred geographic range of proximity to the user of other users the user wants to communicate with.
(5) perform search with the activity-based social networking application and retrieve matching user profiles (system-matched users) on the MCD in real time(0405);
(6) Browse through the matched user profiles and perform action to select or reject the system-matched users (0406);
(7) sending a request with the application to a user of the matched profile (0407);
(8) receiving a response from the user of the matched profile (0408); and
(9) connecting with the user of the matched profile (0409).

One skilled in the art will recognize that these method steps may be augmented or rearranged without limiting the teachings of the present invention. This general method summary may be augmented by the various elements described herein to produce a wide variety of exemplary embodiments.

### An Exemplary Embodiment Application Settings Menu (0500)

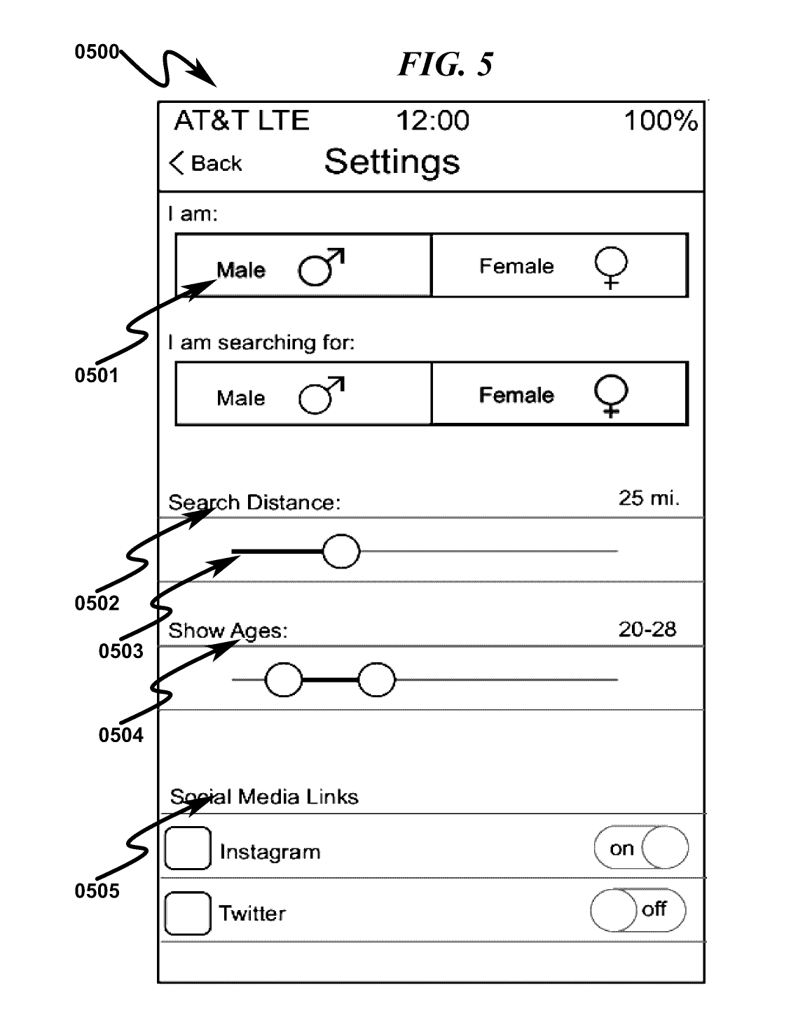

As illustrated below in FIG. 5 (0500), an exemplary settings menu may include options to set search criteria such as gender, distance, age, and social media links. A user may download an activity-based social networking application and display a home screen upon installing the application. The home screen may have a menu to navigate to a settings screen as shown in FIG. 5 (0500). The setting menu may include the user gender information (0501) and a preference for a gender search (0502). For example male user may prefer to search for a male user to perform a weight training activity in a gym. According to an exemplary embodiment, another search preference is a search distance (0502) criteria. The search distance (0502) is taken as the limit to search for user within a certain distance as determined by a GPS system. The distance (0502) may be specified in terms of a sliding scale (0503). It should be noted that a sliding scale for setting search distance is shown for illustration purposes only, any other entry mechanism such as drop down menu, digital tab, and/or circular indicator may be used. An example of search distance is 10 miles radius. Yet another search preference may include age (0504) to indicate activity networking within a certain age range. For example, college users may prefer to network with other college users within a certain age.

An Exemplary embodiment Application Activity Menu (0600-0800)

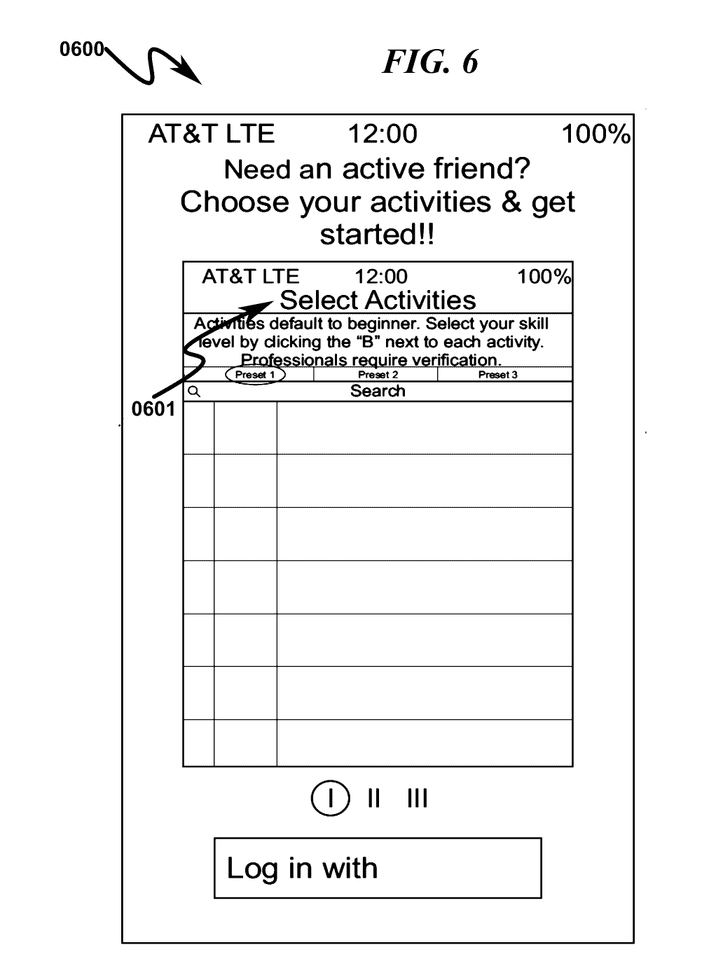

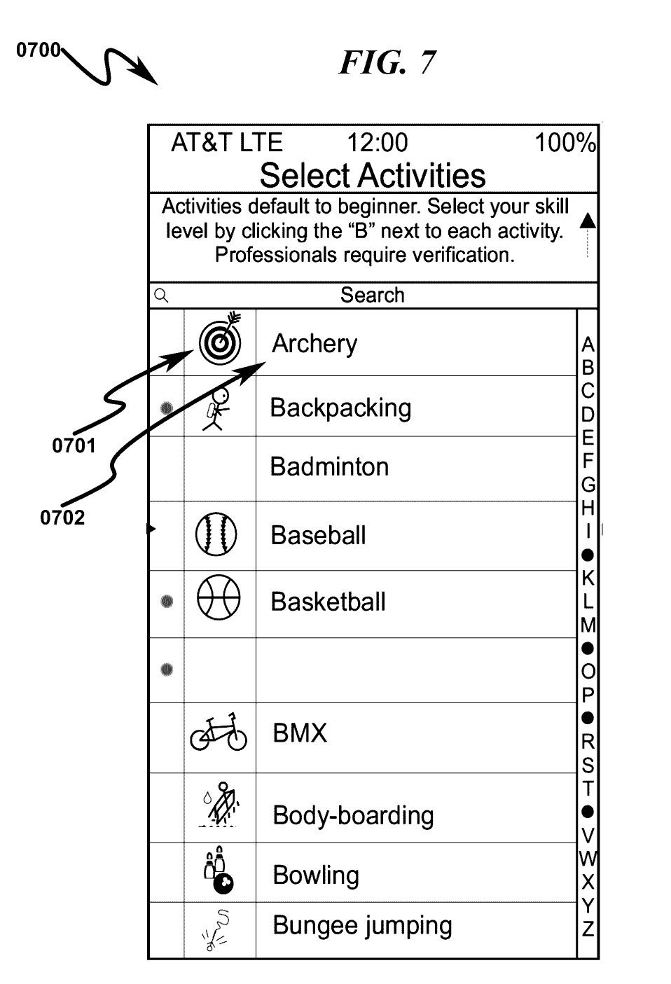

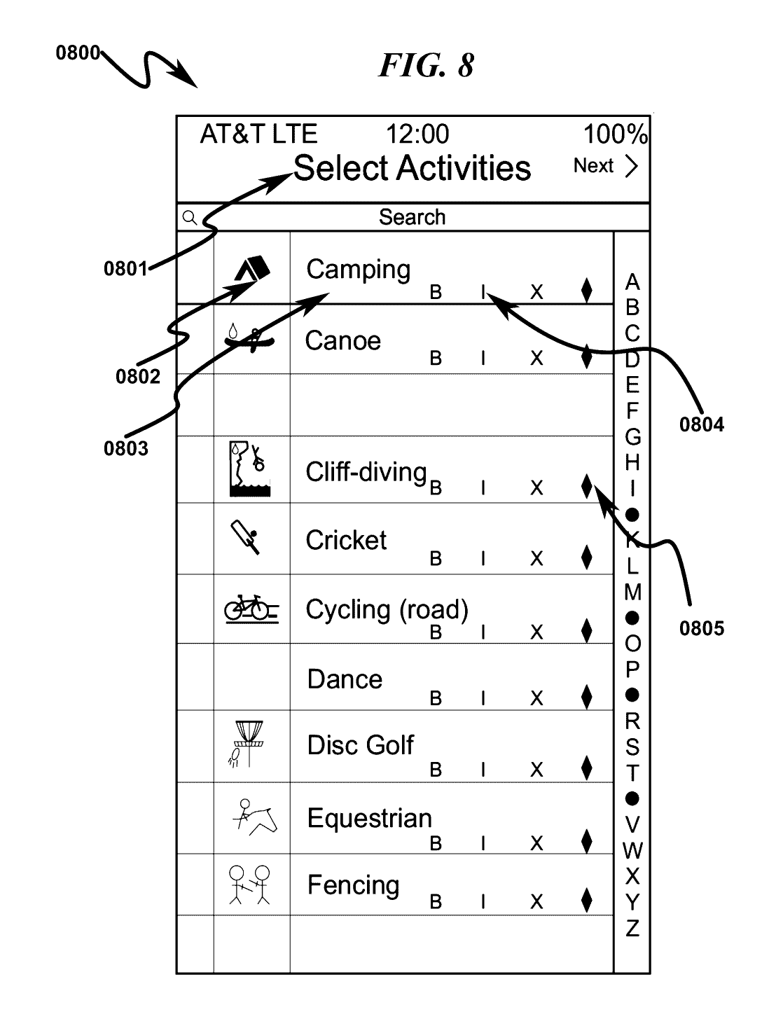

As illustrated below in FIG. 6 (0600), an exemplary settings menu in the activity networking application may include options to set search criteria such as an activity selected from a list shown in Table 1.0. The user may select plural activities at one time with the application. The user may also indicate a proficiency level such as beginner level (“B”), intermediate level (“I”) or professional level (“X”). The professional level may be verified by a recognized third party organization. For example USTA is an organization that certifies user tennis proficiency as amateur or professional and assign ratings. According to an exemplary embodiment, activity networking application enables users to search for matching users based on an activity level and proficiency.

TABLE 1.0
List of Sports/Activities

| | |
|---|---|
| 1 | Archery |
| 2 | Backpacking |
| 3 | Baseball |
| 4 | Basketball |
| 5 | BMX |
| 6 | Body-boarding |
| 7 | Bowling |
| 8 | Camping |
| 9 | Canoeing |
| 10 | Canyoning |
| 11 | Cliff-jumping |
| 12 | Cricket |
| 13 | Cycling (road) |
| 14 | Dance |
| 15 | Disk golf |
| 16 | Equestrian |
| 17 | Fencing |
| 18 | Fishing |
| 19 | Football |
| 20 | Free-Boarding |
| 21 | Fun Runs |
| 22 | Golf |
| 23 | Gymnastics |
| 24 | Hiking |
| 25 | Hockey |
| 26 | Ice-skating |
| 27 | Inline Skating |
| 28 | Kayak |
| 29 | Kickball |
| 30 | Kitesurf |
| 31 | Lacrosse |
| 32 | Long-Boarding |
| 33 | Marathon |
| 34 | Motocross |
| 35 | Motorcycle (Cruiser) |
| 36 | Motorcycle (Sport) |
| 37 | Mountain Biking (MTB) |
| 38 | Mud Runs |
| 39 | Paddle boarding |
| 40 | Paintball |
| 41 | Pilates |
| 42 | Polo |
| 43 | Racquetball |
| 44 | Rafting |
| 45 | Rock climbing (indoor) |
| 46 | Rock climbing (outdoor) |
| 47 | Rodeo |
| 48 | Rugby |
| 49 | Running/Jogging |
| 50 | Sailing |
| 51 | Scuba Diving |
| 52 | Skateboarding |
| 53 | Skydiving |
| 54 | Snorkeling |
| 55 | Snowboarding |
| 56 | Snowmobiling |
| 57 | Snow Skiing |
| 58 | Soccer |
| 59 | Softball |
| 60 | Surfing |
| 61 | Swimming |
| 62 | Tennis |
| 63 | Track & Field |
| 64 | Volleyball |
| 65 | Wakeboarding |
| 66 | Water Polo |
| 67 | Water Skiing |
| 68 | Weight-lifting |
| 69 | Windsurfing |
| 70 | Yoga |
| 71 | Zumba |

### An Exemplary Embodiment Networking Matching Score (NMS)

According to an exemplary embodiment, the activity networking application may use an algorithm to search for users within a geographic distance meeting the specific activity, activity proficiency, age, and gender. The algorithm may compute a networking matching score (NMS) and prioritize the results of the search in a descending order of the matching score. A user may further input weightage to individual factors for calculating the matching score. For example, a user might be constrained by distance and may input a higher weighting versus the activity proficiency level or age. The algorithm considers the weightage of the individual components and computes a matching score as shown below.

Networking Matching Score (NMS)=Function (Distance, Age, Gender, Activity, Proficiency, Weighting factors).
NMS=function (X₁D₁, X₂D₂, X₃D₃, X₄D₄)
Where X₁, X₂, X₃, X₄ are the weightage factors and
X₁, X₂, X₃, X₄ are the search factors such as Distance, Age, Gender, Activity, Proficiency, Weighting factors.

TABLE 2.0
Networking Matching Score (NMS)

| | | | | | | Networking |
|---|---|---|---|---|---|---|
| | | | | Activity | | Matching |
| User | Distance | Age | Gender | Type | Proficiency | Score |
| User1 | 5 | 21 | M | Yes | B | 94 |
| User2 | 15 | 46 | M | Yes | B | 82 |
| User3 | 7 | 76 | F | Yes | I | 64 |
| User4 | 8 | 23 | M | Yes | B | 98 |
| User5 | 9 | 34 | F | Yes | I | 82 |
| User6 | 4 | 42 | F | Yes | I | 86 |
| User7 | 2 | 26 | M | Yes | X | 99 |
| User8 | 10 | 34 | F | Yes | B | 84 |

### An Exemplary Embodiment Networking Activity Search Display (0900-1100)

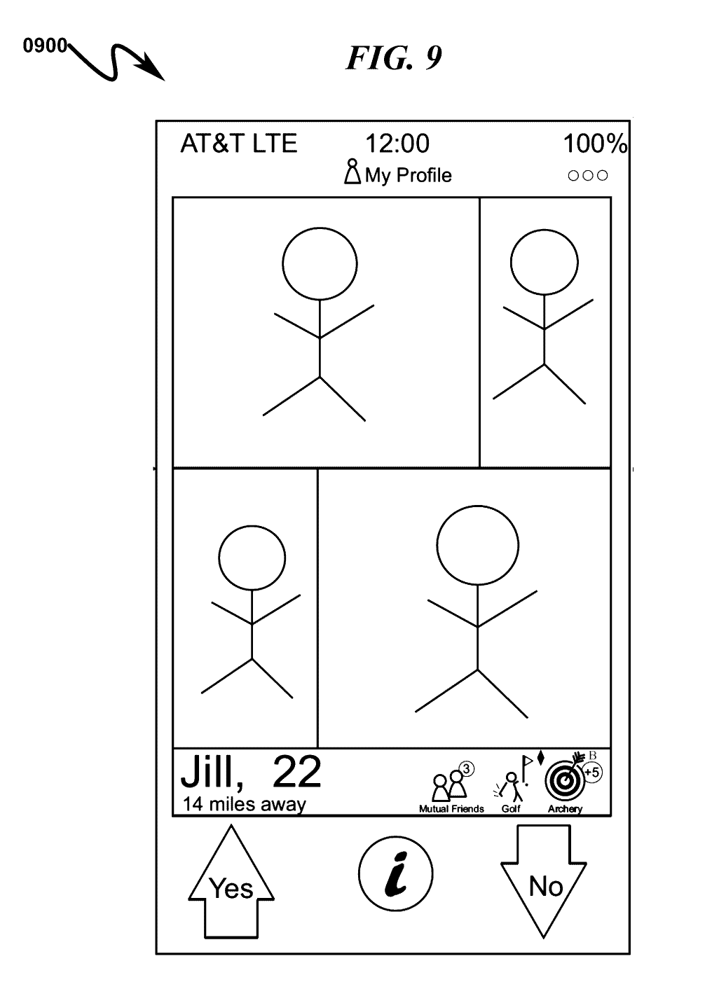

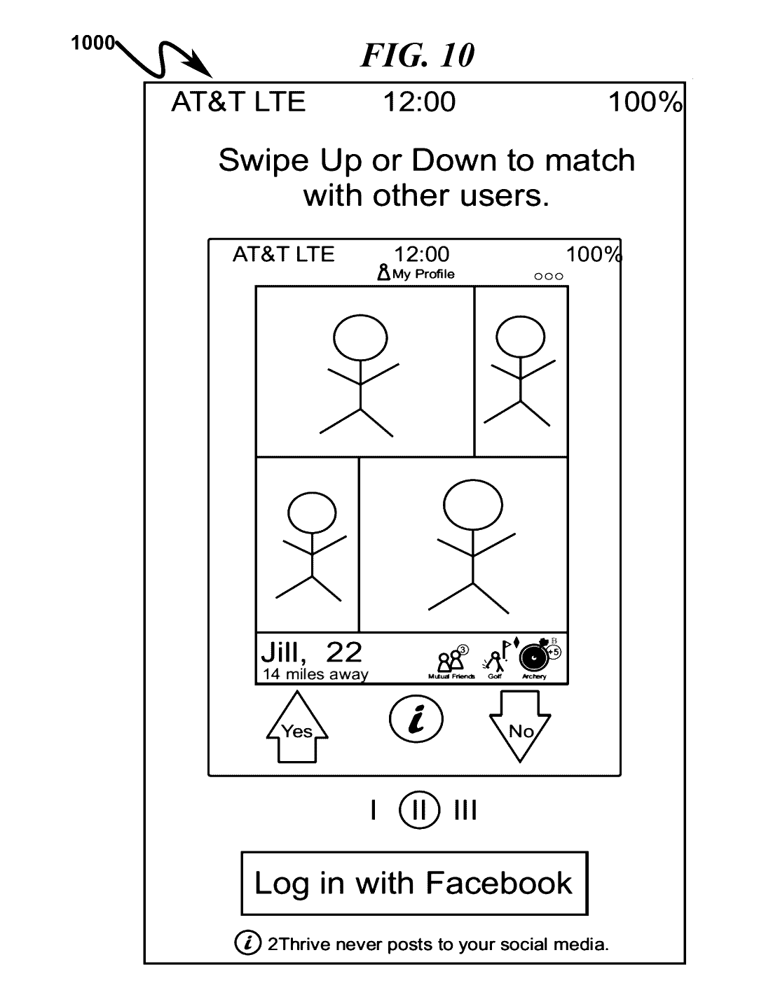

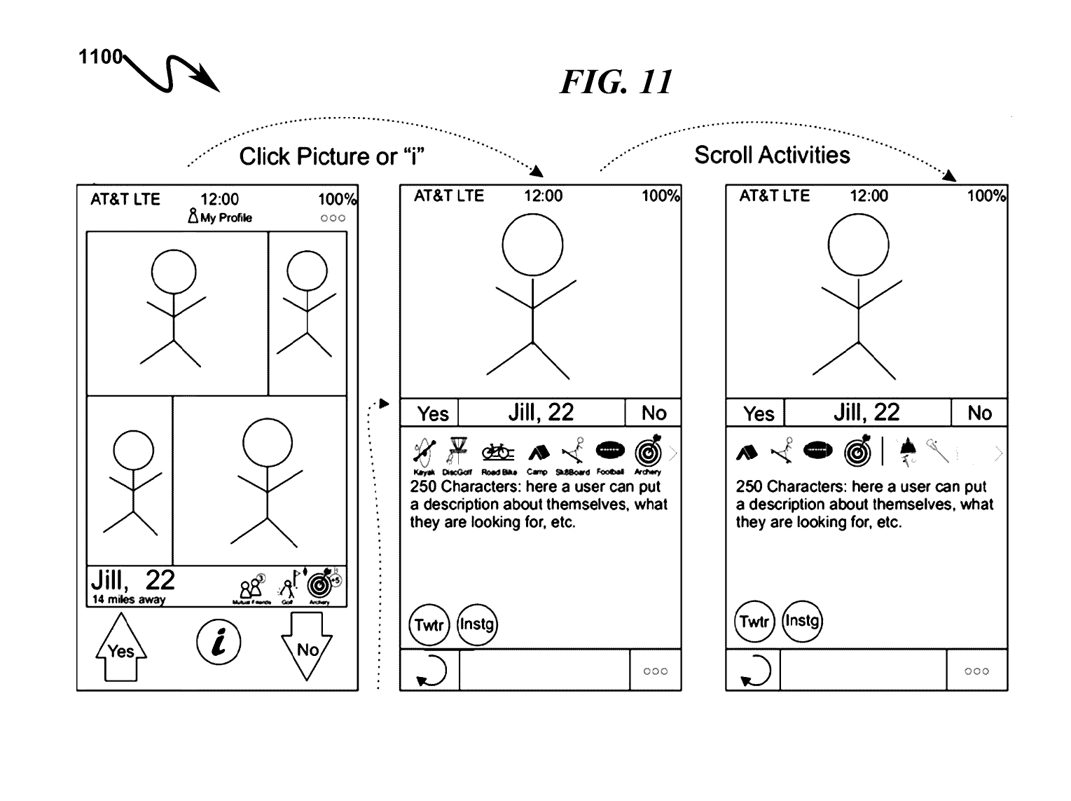

As illustrated in FIG. 9 (0900), FIG. 10. (1000) and FIG. 11 (1100), search results from the exemplary activity networking application may be displayed 4 at a time on the mobile computing devices. The results may be displayed in the order of networking matching score computed by the algorithm. It should be noted that the touch screen display showing 4 matched user profiles is for illustration purposes only and may not be construed as a limitation. The user may select the displayed results one at a time or reject by swiping away gesture. It should be noted that any swiping gesture may be customized to accept or reject a matched user profile. For example, a gesture swiping up a screen may be an acceptance, while swiping down may be a rejection. Similarly, a user may gesture swipe left of a screen to be an acceptance, while gesture swiping right may be a rejection. According to an exemplary embodiment, a user may also delete or block a user from showing up in the matched results based on prior experience or history with the matched user. The user may maintain a list of blocked users in the application so that they do not show up in future search results for system-matched user profiles. The system may also maintain a database of preferred user-profiles that may be selected when the user performs a search based on the user preferences. The system may also perform a search of a database of other users and retrieve user profiles that match the user preferences of the user as system-matched user profiles. The database may be maintained in the on the mobile computing device or on a remote server maintained by the system.

### An Exemplary Embodiment Activity Networking Invitation Method (1200)

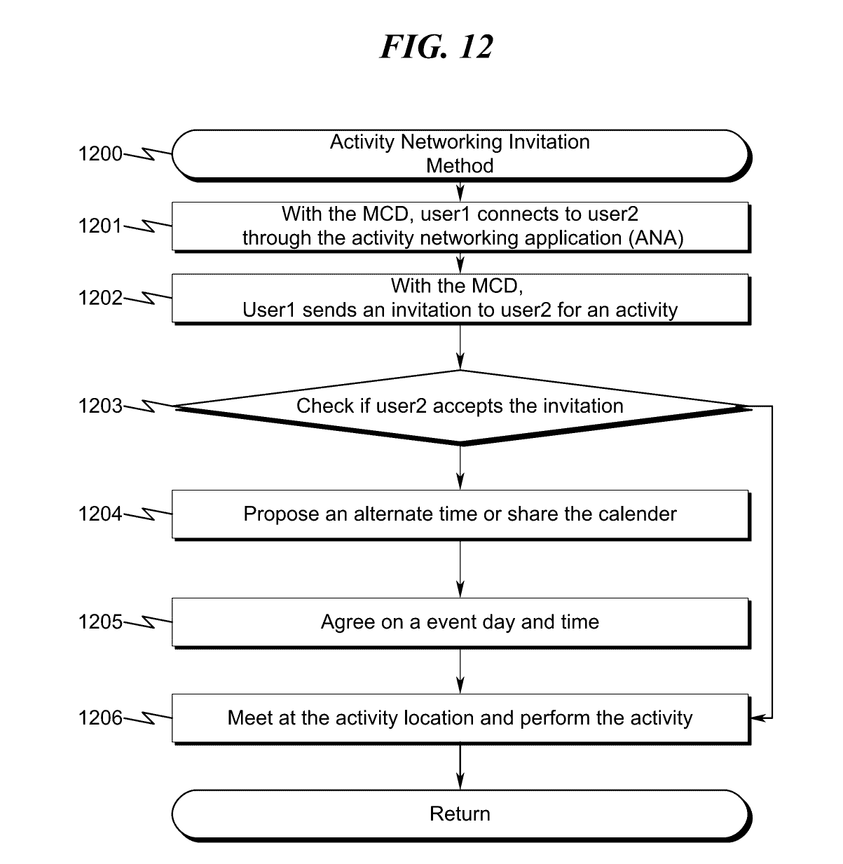

As generally illustrated in the flow chart of FIG. 12 (1200), the exemplary activity networking invitation method may be described in terms of the following steps:
(1) opening the activity networking application and connecting with an user (1201);
(2) sending an invitation for an event at a location to the connected user with the application (1202);
(3) checking for acceptance from said connected user, if so, proceeding to step (1206) (1203);
(4) proposing an alternate time and day or sharing calendars for the event (1204);
(5) agreeing on a time and day for the event (1205); and
(6) meeting and performing the event on the event day and time at the location (1206).

One skilled in the art will recognize that these method steps may be augmented or rearranged without limiting the teachings of the present invention. This general method summary may be augmented by the various elements described herein to produce a wide variety of exemplary embodiments.

### An Exemplary Embodiment Activity Networking Messaging Method (1300-1500)

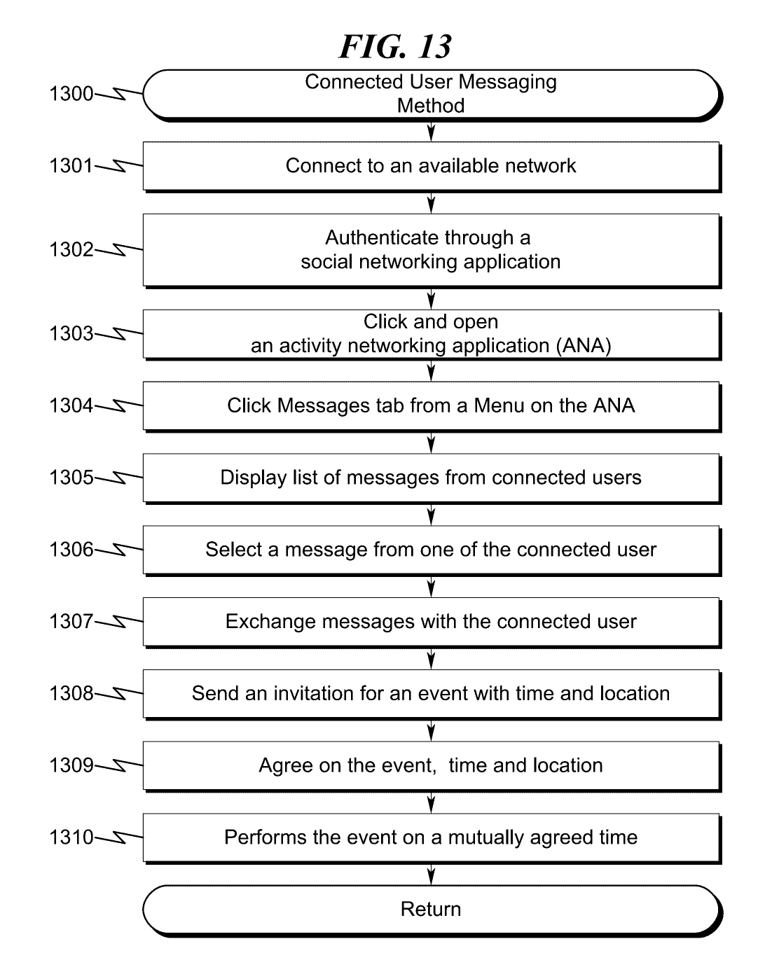

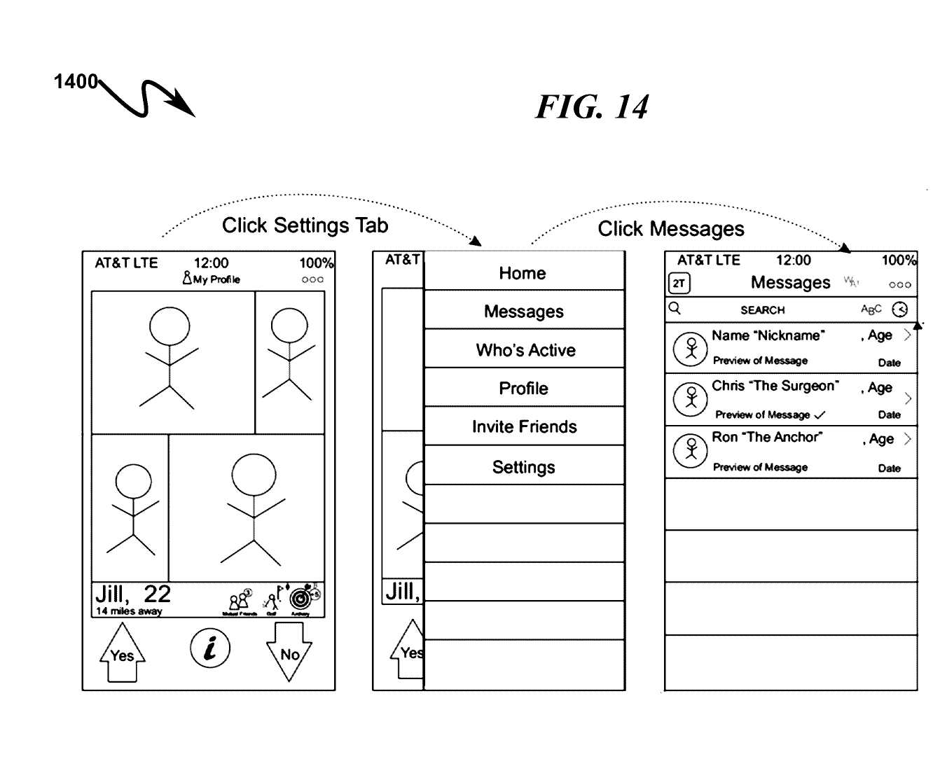

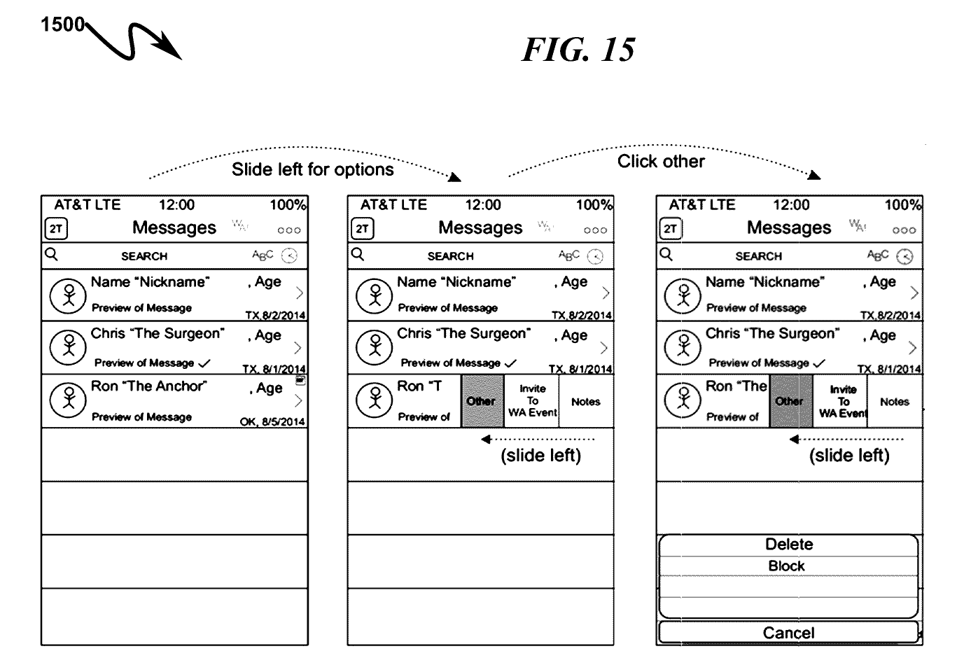

As generally illustrated in the flow chart of FIG. 13 (1300), an exemplary activity networking messaging method may be generally described in terms of the following steps:
(1) connecting to a network (1301);
(2) authenticating through a social networking application such as Facebook™ or Twitter™ (1302);
It should be noted that even though Facebook™ or Twitter™ are mentioned as social networking applications, it should be construed as limitation. Other social networking applications capable of authenticating a user may be used.
(3) opening the activity-based social networking application (1303);
(4) clicking on messages tab from a menu in the application as illustrated in FIG. 14 (1400) (1304);
(5) displaying a list of messages with the application as illustrated in FIG. 15 (1500) (1305);
(6) selecting a connected user message from the list (1306);
(7) exchanging messages with the connected user (1307);
(8) sending an invitation for an event at a location to the connected user with the application (1308);
(9) agreeing on a time and day for the event (1309); and
(10) meeting and performing the event on the event day and time at the location (1310).

One skilled in the art will recognize that these method steps may be augmented or rearranged without limiting the teachings of the present invention. This general method summary may be augmented by the various elements described herein to produce a wide variety of exemplary embodiments consistent with this overall design description.

### An Exemplary Embodiment Active Group Networking Method (1600)

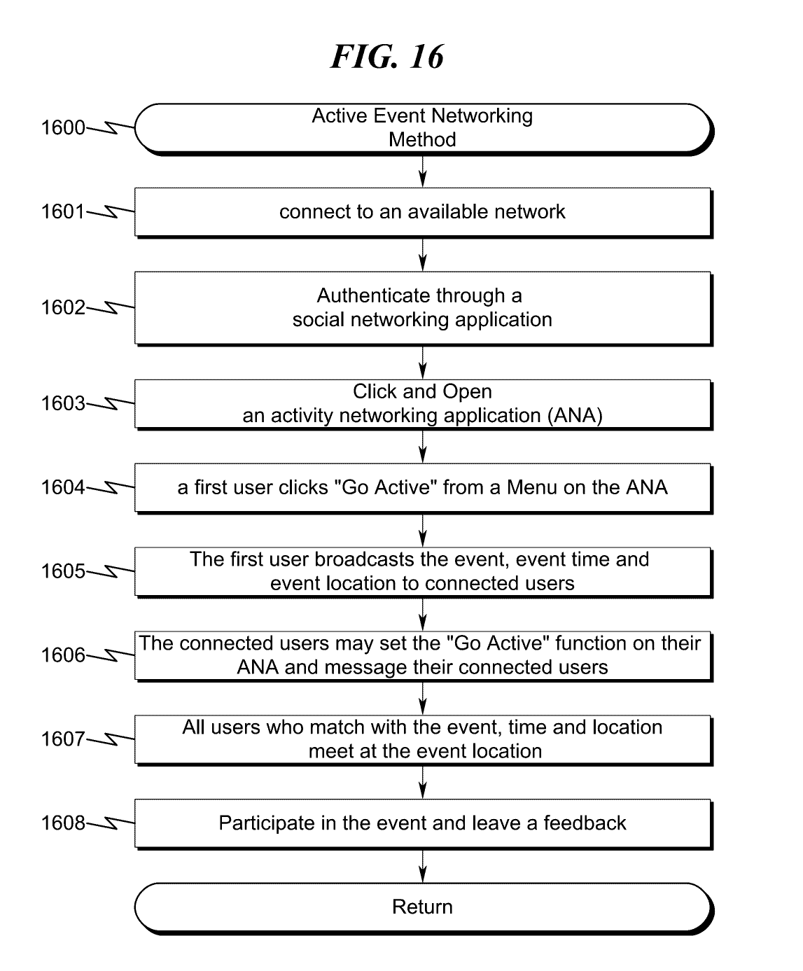

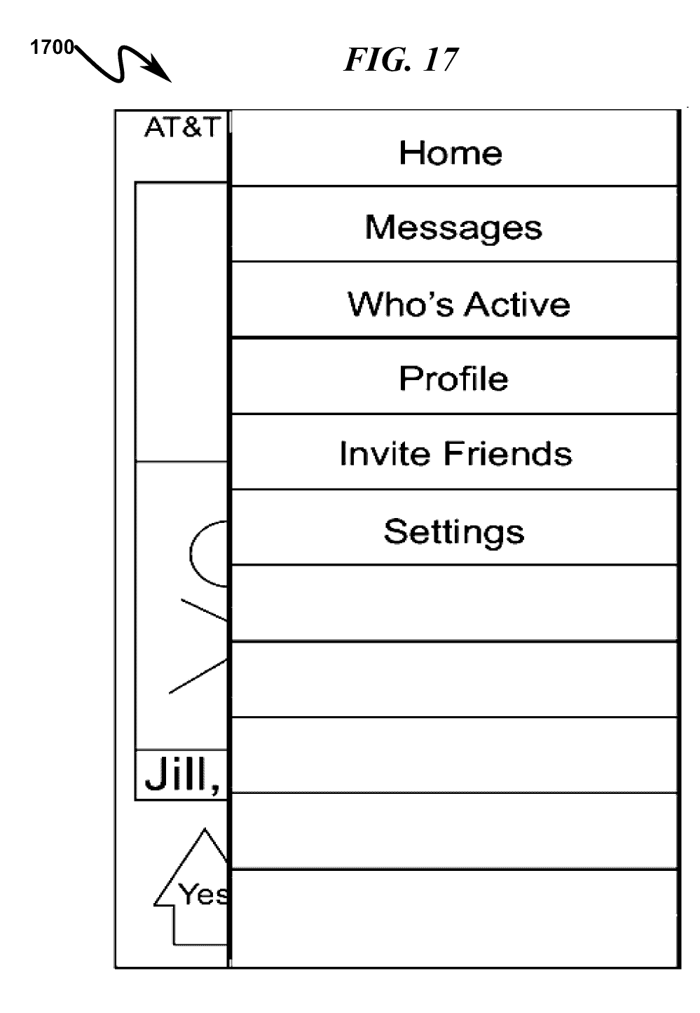

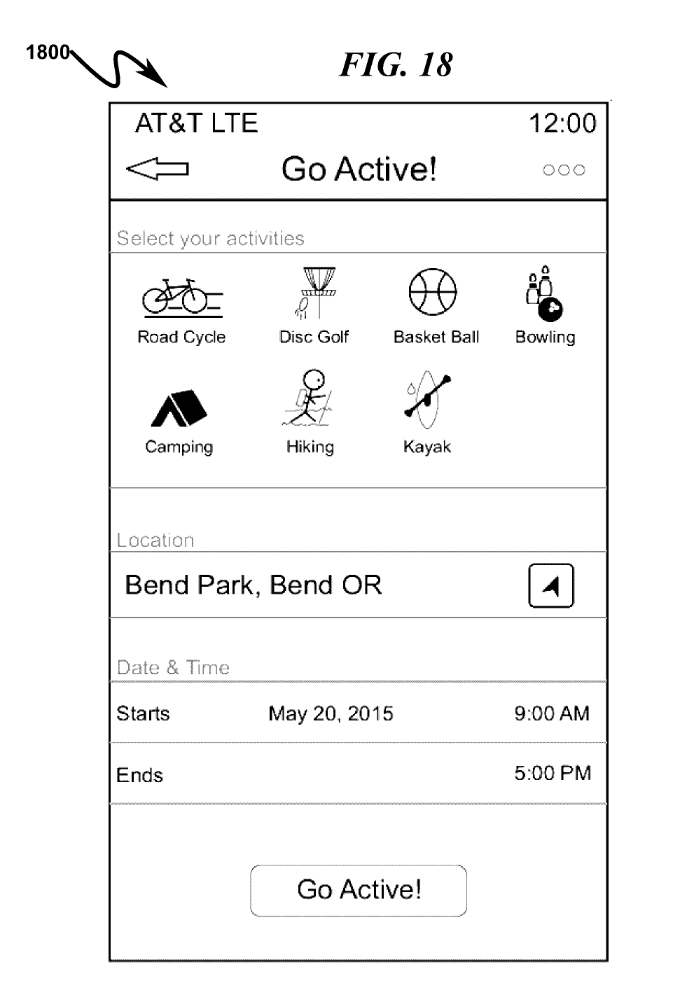

As generally illustrated in the flow chart of FIG. 16 (1600), an exemplary active group networking method may be generally described in terms of the following steps:
(1) connecting to a network (1601);
(2) authenticating through a social networking application such as Facebook and Twitter (1602);
(3) opening the activity networking application as illustrated in FIG. 17 (1700) (1603);
(4) with a first user, clicking on GO ACTIVE tab from a menu in the application as illustrated in FIG. 18 (1800) (1604);
(5) with the first user, broadcasting an event, time, day and location to connected users (1605);
(6) with the connected users, broadcasting the event, the time, the day and the location to their connected users (1606);
(7) with the application, the first user, the connected users and their connected users matching the event, the time, the day and the location (1607); and
(8) meeting and performing the event on the event day and time at the location and leaving a feedback for future events (1608).

Location, as used by the exemplary embodiment and other embodiments of the present invention, may be determined by a street address provided by the user, or may be indicated by a marker on a map dropped and/or pinned to the location by the user.

### An Exemplary Embodiment Activity Dating Method (1900)

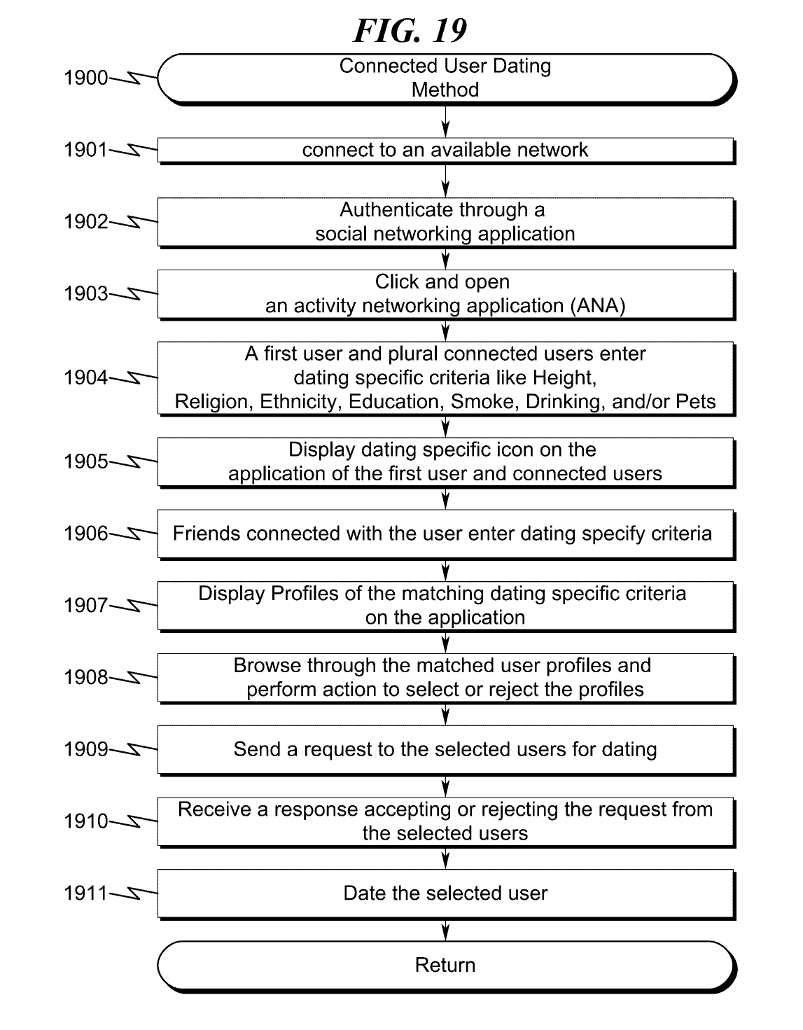

As generally illustrated in the flow chart of FIG. 19 (1900), an exemplary active dating method may be generally described in terms of the following steps:
(1) connecting to a network (1901);
(2) authenticating through a social networking application such as Facebook and Twitter (1902);
(3) opening the activity-based social networking application (1903);
(4) with the activity networking application, a first user and plural connected users entering dating specific criteria (1904); dating specific criteria may include but is not limited to the following criteria.
Height: feet/inches or cm; can choose either measure. If a user puts his/her height in metric and another puts in standard, it the application automatically converts the height so that they can match. Since the application doesn't convert exactly a small range may be tolerated for them to match up.
Religion: Agnostic, Buddhist, Christian, Catholic, Jewish, Muslim, Hindu, Other.
Ethnicity: White/Caucasian, Black/African, Latino/Hispanic, Asian, Indian, Middle Eastern, Mixed/Other.
Education: No Degree, High School, Some College, Bachelor's Degree, Master's Degree, Doctorate Degree.
Smoke: No, Socially, Regularly.
Drinking preferences: No, Socially, Regularly.
Dogs, cats, or both.
(5) displaying a dating specific icon on the first user activity networking application and the plural connected user activity networking applications (1905);
(6) searching for matching profiles with the application (1906);
(7) displaying matching profiles based on the dating specific criteria (1907);
(8) browsing through the matched user profiles (system-matched users) and perform action to select or reject the profiles (1908);
(9) sending a request for dating to the accepted matched user (1909);
(10) receiving an acceptance response from the accepted matched user (1910); and
(11) dating the accepted matched user (1911).

One skilled in the art will recognize that these method steps may be augmented or rearranged without limiting the teachings of the present invention. This general method summary may be augmented by the various elements described herein to produce a wide variety of exemplary embodiments consistent with this overall design description.

### An Exemplary Embodiment Snap Reporting Method (2000)

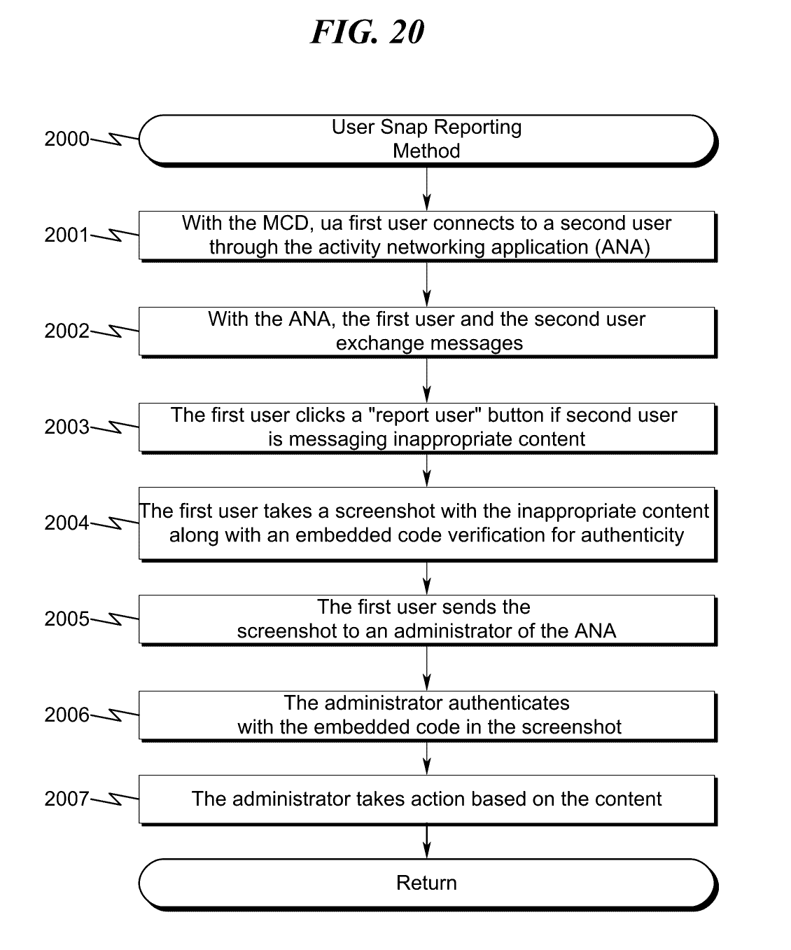

As generally illustrated in the flow chart of FIG. 20 (2000), an exemplary snap reporting method may be generally described in terms of the following steps:
(1) with the activity-based social networking application, connecting a first user connects with a second user (2001);
(2) exchanging messages between the first user and the second user (2002);
(3) clicking a user report button if a user messages inappropriate content (2003);
(4) taking a screenshot with an embedded verification code of the inappropriate content (2004); the user may take a screenshot within the application that will automatically add a coded verification to the screenshot where an administrator can click on the picture and go straight to the content;
For example: Jill takes a screenshot of an inappropriate message from John. After she sends in the screenshot, an administrator can click on the screenshot and it will direct to that part of the message where the content lies that need to be reviewed;
(5) sending the screenshot with the embedded verification code to an administrator (2005);
(6) authenticating said screenshot with said embedded verification code (2006); and
(7) acting based on said inappropriate content (2007). The user may report based on content, pictures of the user, and spam.

One skilled in the art will recognize that these method steps may be augmented or rearranged without limiting the teachings of the present invention. This general method summary may be augmented by the various elements described herein to produce a wide variety of exemplary embodiments consistent with this overall design description.

### System Summary

An exemplary embodiment of a system includes a wide variety of variations in the theme of activity networking, but can be generalized as “a mobile social activity networking system configured for facilitating event planning and coordination of activities between system-matched users of the system.” The system is configured for use on mobile computing devices (including but not limited to smart phones, tablet computers (such as iPad® and Surface®), for example) that are operatively configured with global positioning system capability. The system is further configured to enable a system user to input user preferences via a downloaded networking application. The user preferences may include preferred activities the user wants to engage in, the preferred geographic range of proximity to the user of other users the user wants to communicate with; and communicate with other users of the system conforming to the user's input user preferences to facilitate organizing a time and place to meet for a planned activity or event that includes at least one of the input user preferences. The system uses the input user preferences of users and the users location based on the global positioning system indication of the users location to match user's with each other to create system-matched users.

Another present exemplary embodiment system anticipates a wide variety of variations in the basic theme of activity networking, but can be generalized as a mobile social activity networking system for facilitating event planning and coordination of activities between system-matched users of the system. The system is configured for use by a plurality of users that each have a mobile computing device operatively configured with global positioning system capability. The system is configured to enable a user to use the mobile computing device to download an activity networking application into the mobile computing device, and the system authenticates the download and authorizes the user, based on user data input via the downloaded social networking application. The system further receives user input preferences including demographic data defining other users the user wants to interact with, preferred activities the user wants to engage in, the preferred geographic range of proximity to the user of other users the user wants to communicate with. The system selects user profiles that match the user input preferences of the user and presents them as system-matched user profiles and enable the user to view and browse through the system-matched user profiles on the user's mobile computing device, perform an action to accept or reject a user profile, send a request to an accepted system-matched user and receive a response from the accepted system-matched user.

Yet another present exemplary embodiment system anticipates a wide variety of variations in the basic theme of activity networking, but can be generalized as a mobile social activity networking system configured for facilitating event planning and coordination of activities between system-matched users of the system. The system is configured for use by a plurality of users that each have a mobile computing device operatively configured with global positioning system capability, with touch-activated graphic user interface, and with communications capability through telephony or wifi, or both. The system is further configured to:

enable a user to use the mobile computing device and download an activity networking application into the mobile computing device, and the system authenticates the download and authorizes the user, based on user data input via the downloaded activity networking application;

receive user input preferences, including demographic data defining other users the user wants to interact with, preferred activities the user wants to engage in, the preferred geographic range of proximity to the user of other users the user wants to communicate with;

identify as system-matched user profiles, user profiles of others in a database that conform to the user's input preferences; and

enable the user to:

browse through the system-matched user profiles on the graphic user interface of the user's mobile computing device;

perform an action to accept or reject a browsed user profile;

send a communication to an accepted browsed user profile; and

receive a responsive communication from the accepted user profile.

This summary of exemplary systems may be augmented by the various elements described herein to produce a wide variety of invention embodiments consistent with this overall design description.

### Method Summary

An exemplary embodiment of the methods anticipates a wide variety of variations in the basic theme of implementation. The system comprises users using mobile computing devices (MCDs) equipped with global positioning devices. The exemplary method can be generalized as a mobile social activity networking method wherein some of the method steps are performed by the system and other steps are enabled by the system to be carried out by the users, using the mobile social activity application on their mobile devices. The method comprises using a system that is configured such that it enables the users to carry out the steps of:
(1) with the mobile computing device, connecting to a network;
(2) loading an activity networking application into the mobile computing device;
(3) authenticating through a social networking application;
(4) inputting user preferences, such as choosing activities indicating proficiency level and selecting range of distance to search for potential other users that match;
(5) performing searches with the application and retrieve “matching user profiles” on the mobile computing device in real-time (since users may be travelling and GPS location can vary);
(6) browsing through the matching user profiles (system-matched users) and performing an action to accept or reject a user profile;
(7) sending a request with the application to a user with the system-matched profile;
(8) receiving a response from the user with the matched profile; and
(9) connecting with the user of the system-matched profile.
In the method, the system creates the matches between the user profiles (“system-matched user profiles”) based on the input preferences of the users.

This general method summary may be augmented by the various elements described herein to produce a wide variety of exemplary embodiments consistent with this overall design description.

### System/Method Variations

As explained, the examples presented above do not limit the scope of the inventions.

In an exemplary embodiment, when the system user travels to a new location, the system detects the user's location using the global positioning system capability of the mobile computing device of the user, and the system automatically uses the user's input geographic range (distance from other prospective users for planned events/activity) preferences to allow the user to communicate with other users at the new location (which is his/her travel destination, if he/she has arrived) that conform to the user' input user preferences.

An exemplary embodiment wherein the system is further configured to enable a system user to:

download an activity-based social networking application onto a mobile computing device, and

register as an authenticated user of the system;

wherein the user preferences further include demographic data defining other users that the user wants to interact with.

Optionally, one of the preferred activities is dating.

Optionally, one of the preferred activities is playing a sport.

Optionally, one of the preferred activities is an event initiated by an administrator of the social networking system.

Optionally, one of the preferred activities is an event initiated by at least one of the system-matched users.

Optionally, at least one of the preferred activities has a proficiency level; and the system uses proficiency level to determine the system-match users.

Optionally, the system-matched users are determined by the social networking application based on a network matching score; the network matching score is computed from the demographic data, the geographical range, the preferred activity and a proficiency level.

Optionally, the system further enables the user to accept or reject system-matched users with a gesture on the touch screen of the mobile computing device.

Optionally, the system performs a search of a database of other users and retrieves user profiles of others that match the user preferences of the user as system-matched user profiles.

Optionally, and alternatively, the system computes a network matching score based on the user preferences of the user to determine system-matched user profiles.

Optionally, system further enables the user to accept or reject a system-matched user profile with a gesture on the touch screen of the mobile computing device.

Optionally, the system further enables the user to accept or reject a system-matched user profile with a keyboard on the mobile computing device.

Optionally, the system further enables the user to reject a system-matched user profile based on a blocked list created by the user of other users that he/she does not want to communicate with; the blocked list maintained on the activity application of his/her mobile device, and amendable by the creator-user.

Optionally, the system further enables the user to automatically accept a system-matched user profile based on a preferred list; the preferred list created, maintained and amendable by the user on the activity application of his/her mobile device.

Optionally, the system further enables the user to send an invitation to an accepted system-matched user (i.e. a connected user) for an event at a location; and upon acceptance from the connected user, the user and the connected user agree to the time and place of the event.

Optionally, the system further enables the user to send an invitation to an accepted system-matched user (connected user) for an event at a location; and upon rejection from the connected user, the system proposes an alternate time and day and shares a calendar for the event; and upon acceptance from the connected user, the user and the connected user agree and to perform the event at the time and place.

Optionally, the system further enables messaging between a user and at least one of the system-matched users, wherein the system displays a list of messages when the user clicks on a “messages” tab from a menu in the activity application; and enables the user to select a connected user message from the list; exchange messages with the connected user; send an invitation for an event at a location to the connected user; agree on a time and day for the event; and arrange to meet on the day and the time at the location.

Optionally, the system is further configured to facilitate reporting by the user during exchanging of messages. The system enables the user to click a “user report button” on the social activity networking application, when another user sends messages to him/her with “inappropriate content.” The user may take a screenshot with an embedded verification code of the inappropriate content; and send the screenshot to an administrator. When the system authenticates the screenshot with the embedded verification code, the administrator can determine what action to take based on the asserted inappropriate content.

One skilled in the art will recognize that other embodiments are possible based on combinations of elements taught within the above invention description.

### An Exemplary Embodiment Activity Group Networking System Diagram (2100-2700)

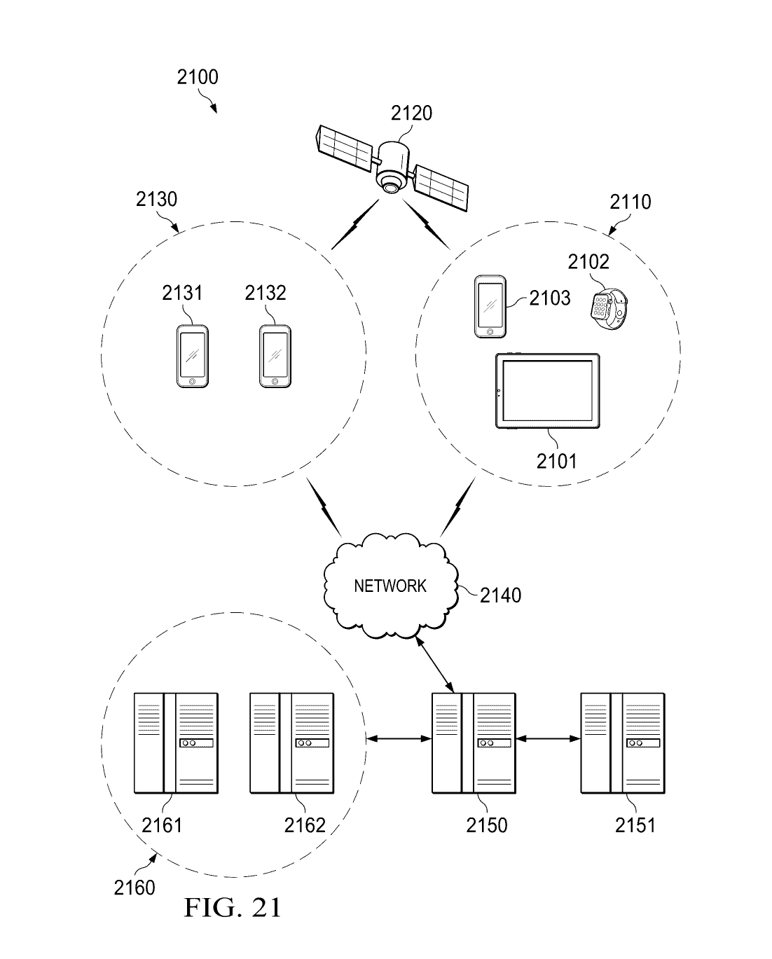

Another exemplary embodiment of the present inventive technology may be seen in more detail as generally illustrated in FIGS. 21-27 (2100-2700) for further facilitating event planning and coordinating activities between users of the system. Users may congregate into groups of users, and the groups may be dedicated to a specific or particular activity. These groups are associated with a geographic area so that the users of the group may easily organize to get together (in person) for a specific or particular activity. These groups of users may be organized by third parties, and the third parties' servers may provide services through these groups. Third parties may include but are not limited to gyms, sporting associations, stores, clubs, and any other type of organization that foresees benefits from a grouping of individuals of interest. Groups may be of a variety of types where either the individuals have some factor in common, or another party perceives them as having a factor in common. Thus, for example, there may be sponsored groups (which may be groups sponsored by or affiliated with a third party), featured groups (which may be groups recommended by an administrator of the system), social groups (which may include persons with social issues in common), approved groups (which may be groups that have passed the approval process by an administrator of the system), and local groups (which may be groups in a particular geographic location), etc.

An exemplary embodiment provides a system 2100 for facilitating the creation of groups in the present inventive technology. As with previous exemplary embodiments, users each carrying a mobile computing device 2131, 2132, 2101, 2102, and 2103 may be physically separated from each other by distance but are within “distance circles” (2130 and 2110) defined by the radius within which they have identified that they want to interact with others. The mobile devices 2131, 2132, 2101, 2102, and 2103 are enabled with global positioning receivers/devices that connect to a global positioning system 2120 for keeping track of the location of the mobile devices. The mobile devices calculate a relative location of the user, and connect to the mobile web server 2150 by connection to a communications network 2140. The mobile web server 2150 is in turn connected to mobile application server 2151. The mobile web server 2150 is also connected to third party servers 2161 and 2162 in distance circle 2160. The term “distance circle” may be used interchangeably with “circle,” “area,” “range”, “distance” and any other term that refers to the area defined by a radius from the center of the area, where the radius is also a distance from one point to another point. The radius may be identified by the user as a distance within which they want to interact with other users or groups of the system. The mobile computing devices 2131, 2132, 2101, 2102, and 2103 computes a distance circle for a user using the calculated relative location, and the mobile computing devices 2131, 2132, 2101, 2102, and 2103 identify users and groups located within the distance circle. The mobile computing devices 2131, 2132, 2101, 2102, and 2103 also identify users with mobile computing devices that have computed a different distance circle, and the different distance circle overlaps with the distance circle 2130 and 2110 computed by the mobile computing devices 2131, 2132, 2101, 2102, and 2103. The overlap between the two distance circles may be referred to as a “positional overlap” or a “geographical overlap.”

The term “computing device” means any electrical device capable or accepting stored program instructions from a computer readable medium and processing those program instructions to perform a defined task. Such devices include, but are not limited to, a mainframe, workstation, desktop, laptop, notebook, or tablet computer, a database server, web server, or the like. One of ordinary skill in the art will appreciate that the construction, choice of programming language, programming, operation, and functionality of such computer processing devices is well known, rendering further description of such devices unnecessary in this regard.

Third party servers (TPS) 2161 and 2162 are generally operated by third parties and/or groups of users. Third party servers 2161 and 2162 refers to a server that hosts, installs, and operates services associated with the mobile applications on mobile devices. Third party servers 2161 and 2162 also provide information data about the group, and are capable of accepting stored program instructions from a computer readable medium and processing those instructions to perform a defined task. One of ordinary skill in the art will appreciate the construction, choice of programming language, programming, operation, and functionality of servers is well known, rendering further description of such devices unnecessary in this regard.

The present exemplary embodiment provides additional circles for third party servers. Third party servers may be stationed locally with the third parties or remotely. Because third party servers are associated with groups and groups are associated with a geographic area, the third party servers located locally are also associated with the same geographical area as the group associated with the third party server. For third parties, like stores, clubs, organizations, that have a permanent location, the third party circles may indicate the geographical area for the permanent location of the third parties

A user with a mobile computing device with the mobile application may set a geographic range/distance to connect with other users of the system 2100. The user may also connect with groups within the same geographic range/distance. The mobile computing device determines the relative location of the mobile computing device via the GPS coordinates and information retrieved from the global positioning system 2120 via by the GPS receiver. The mobile computing device connects with the mobile web server 2150 and with the mobile application server 2151 to search for groups within the geographic range/distance from the relative location of the mobile computing device. Because groups have their own geographic location and geographic area, if the geographic range were to overlap with the group's geographic area and/or location, then the group profile appears on the mobile application on the mobile computing device for the user to select, browse, join, etc.

In another embodiment, an email and password sign-up may appear on the interface of the mobile application on the mobile device. The email and password sign-up allows users to create a group, with a profile page that incorporates a summary of activities for the group, an address, link to a map application or a navigation application, phone numbers, websites, etc. The address of a group may be identified by a street address or by the user identifying a location on a map using a marker dropped/pinned to the location on the map.

### An Exemplary Embodiment Application Groups Menu

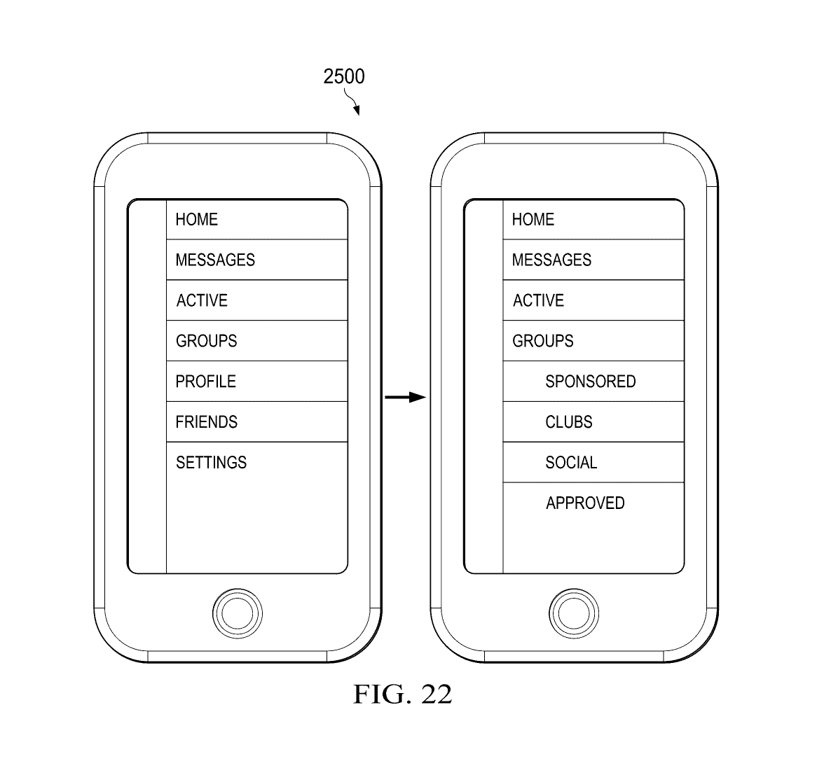

As illustrated below in FIG. 22 (2200), an exemplary menu may include options to view types of groups. Types of groups include sponsored groups, clubs, social groups, and approved groups. The home menu may have a menu to navigate to the group category menu as shown in FIG. 22 (2200).

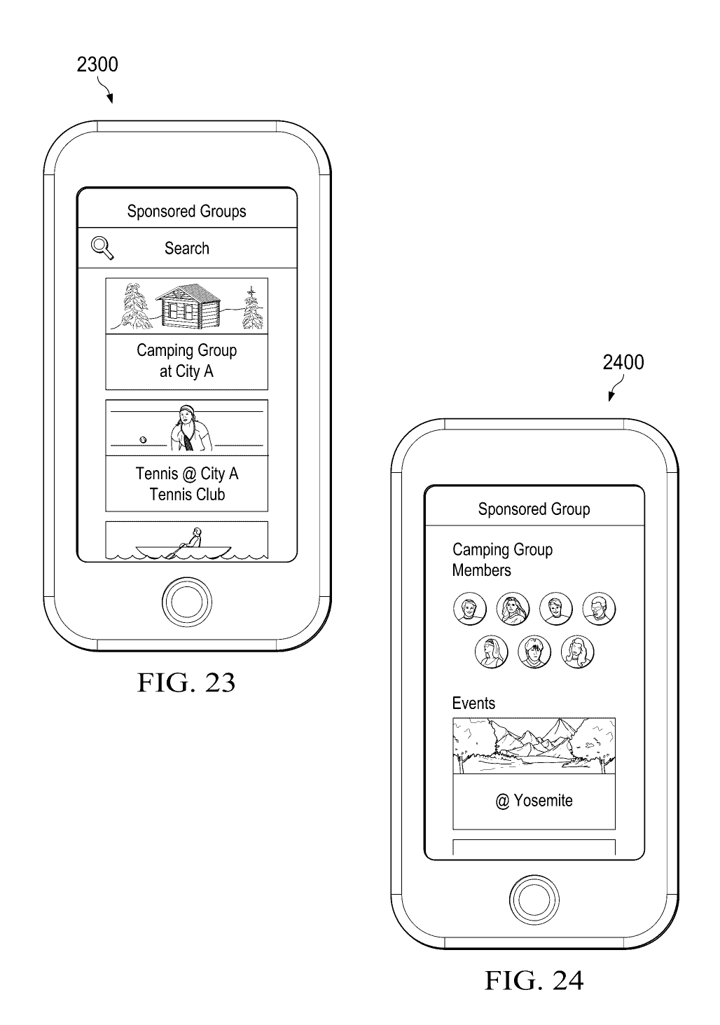

FIG. 23 (2300) depicts an exemplary illustration of a list of groups that a user may view on the mobile application on the mobile computing device. The mobile computing device connects to the mobile web server, the mobile application server, and/or the third party servers in order to populate a list of groups for the user to select, browse, join, etc. The groups may be ordered based on the proximity to the user of a geographic location associated with the group or the distance circle associated with the group. A user may also search for a specific group, groups that participate in a particular or specific activity, groups within a different geographic area, etc.

Some groups may also not appear to the user even though the group may be within the geographic range of the user's mobile computing device. Groups may set their own geographic range/distance for members, and groups may also set restrictions on their membership. For example, a group associated with Gym A may set the membership for the group to be restricted to only Gym A members. Groups may also set other restrictions for users, such as activity proficiency, demographic data, networking matching score, and can restrict membership of the group using the user matching technology as disclosed in the present inventive technology.

### An Exemplary Embodiment Application Group Profile (2400)

As illustrated below in FIG. 24 (2400), an exemplary group may have a profile page to display information about the group. A group profile may provide information about the group, such as members of the group, events the group is putting on, promotions the group is hosting, rental activities associated with the group, etc. Information about the group may be retrieved from the mobile web server, the mobile application server, and/or the third party servers. Information about the group may also be hidden from users that are not members of the group. Furthermore, the group profile may also hide information from users if the mobile computing devices determines that the geographic range/distance based on the relative location of the mobile computing devices does not overlap with the geographic range for social activities. For example, a group associated with a national chain of gyms may host an event with a local gym and this event may appear to users only with a specific geographic range/distance from the local gym. So users may be a part of the group but not be able to see or access this local event because the users are not within the geographic area of the local gym. Relative location is calculated by using the address associated with the group, or by a dropped/pinned marker on a map on the mobile application.

Examples of events that groups may host include get-togethers, meetings, classes, etc. These events may be one-time events or repetitive events, like classes. These events, like groups, may be hidden and/or restricted using the user matching technology as disclosed in the present inventive technology, such as demographic data, networking matching score, activity proficiency, etc.

Information about events that groups host is shared between the mobile web server and the third party servers associated with the events. The information is shared between the servers in order to maintain accurate counts of availability of event participation because people outside of the system may sign up for the event in person or through other websites and resources.

In another embodiment, a user signs up or joins an event hosted by a group; however the user may then migrate to another geographic area not within the geographic area specified by the event hosted by the group. The event may be of a kind that requires a certain number of users to participate, and the user's migration outside of the specified geographic area for the event may disrupt the event from proceeding forward. Because the mobile computing device keeps track of the relative location of the mobile computing device and of the specified geographic area of the group event, the mobile computing can determine whether the user has migrated to a geographic area that is not within the geographic area specified by the event. Once the mobile computing device determines that the user has migrated out of the specified geographic area for the event, the mobile computing device sends a message to the mobile web server, mobile application server, and/or the third party servers. The mobile web server adjusts the information about the event hosted by the group accordingly, and as a result may open the event up for other users to join if the event was hidden because the number of users required for the event had been reached. The user that migrated from the geographic area of the event may still receive messages directed at the event.

Groups may have a blocked list maintained by administrators of the group. Groups with a blocked list would prevent users on the blocked list from joining the group.

Alternatively, groups may have a preference list maintained by administrators of the group. Groups with a preference list would automatically accept users that meet certain criteria with regards to activities, geographic location, proficiency level, etc.

### An Exemplary Embodiment Group Promotions (2500-2600)

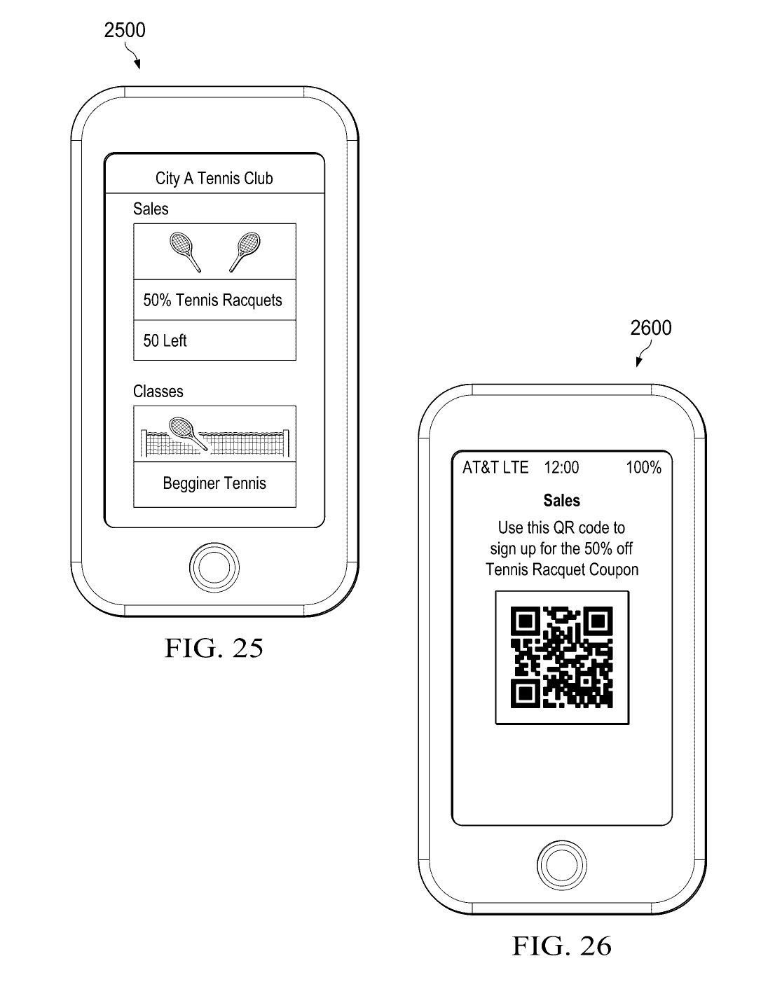

As illustrated in FIG. 25 (2500), groups may be associated with retail third parties, and the group profile may display promotions associated with the retail third parties. The mobile computing device may retrieve from the mobile web server information from the third party servers regarding retail sales, rentals, and/or promotions. Retail sales, rentals, and/or promotions by third parties may be limited in time or quantity for group members or for users in general. As with group related events and information, third party retail sales, rentals, and/or promotions may or may not be available to users if the mobile computing device determines that the mobile computing device is out of range from a specified geographic area associated with the third party retail promotion.

Furthermore, FIG. 26 (2600) depicts an exemplary illustration of a third party retail promotion using a QR code. Third party retail promotions may take on the appearance of QR codes, barcodes, or any other optical machine-readable representation of data relating to the advertisement and/or promotion. A user who has signed up for the third party retail promotions may be able to use any optical machine-readable code at a certain location as provided by the promotion. The optical code may be used at any participating location associated with the third party. As with other group related events and information, the third party promotion may be hidden if the mobile computing device determines that geographic range/distance based on the relative location of the mobile computing device does not overlap a geographic area specified for the third party promotion.

Alternatively, promotions could involve showcasing events, such as group events or classes hosted by the group. For example, a third party promotion could provide for 50% off gym membership dues if a user were to sign up for a gym membership during a certain time frame.

In another embodiment, a user signs up for a promotion hosted by a group; however the user migrates to another geographic area not within the geographic area specified by the promotion hosted by the group. The promotion may be the type of promotion that is available to only a limited number of users, and a user migrating outside of the specified geographic area for the event changes the availability of the promotion to other users. Because the mobile computing device keeps track of the relative location of the mobile computing device and of the specified geographic area of the group promotion, the mobile computing can determine whether the user has migrated to a geographic area not within the geographic area specified by the event.

Once the mobile computing device determines that the user has migrated out of the specified geographic area for the event, the mobile computing device may notify the user that he or she may no longer be signed up for the promotion by migrating out of the specified geographic area. The user may indicate that he or she intends to return to the specified geographic area within a specified time frame, and the mobile computing device transmits a message to the mobile web server, mobile application server, and/or the third party servers informing the system. The mobile web server adjusts the information about the promotion hosted by the group accordingly, and the mobile computing device may continue to determine whether the user has migrated back into the specified geographic area.

If the user indicates that he or she will not be in the specified geographic area to use the promotion, then the mobile computing device transmits a message to the mobile web server, mobile application server, and/or the third party servers informing the system. The mobile web server adjusts the information about the promotion hosted by the group accordingly, and may open the promotion up for other users to sign up if the promotion was hidden because the user limit for the promotion had been reached. The user that migrated from the geographic area of the event may still receive messages directed at the promotion.

In another embodiment, the group may be associated with a third-party payment system, like PayPal, in order to assist users and/or members of the group to use promotions or to attend paid events The mobile web server, in communication with the third party servers, connects with a third party payment system in order to facilitate a financial transaction by the user to the third party payment system, and the third party system, in turn generates a financial transaction that transfers funds from the third party system to a financial account. The financial account would be with a third party financial institution but the information for the transfers of funds to the financial account is held by the third party payment system. The information for financial transfers or for financial transactions for the third party server may be stored with the third party server or with the mobile web server in order to expedite the financial transaction process. Once the financial transaction is complete, the third party system sends a confirmation to the third party server or the mobile web server, and the servers communicate with each other to maintain accurate accounts of event or promotion availability.

### An Exemplary Embodiment Group Locations Listing

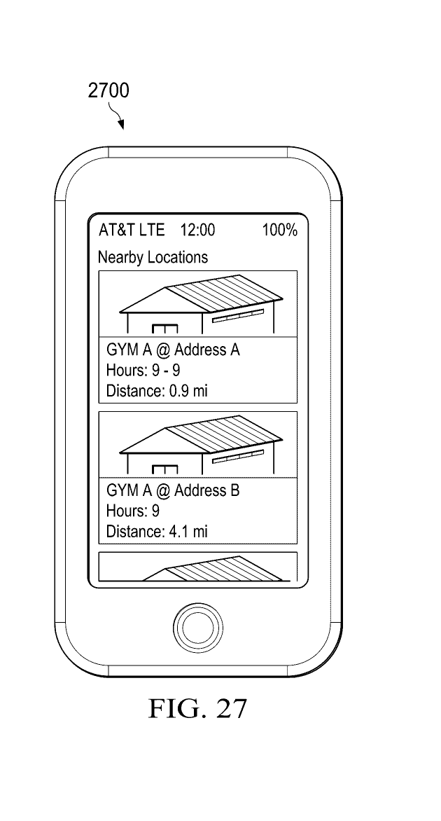

As illustrated below in FIG. 27 (2700), groups that are associated with a chain or franchise operation may display a list of establishments of the chain or franchise operation. The group profile of the mobile application may provide a link to display the list of establishments. As with other exemplary embodiments of the present inventive technology, the mobile computing device determines whether an establishment appears on the list of establishments by determining whether the establishment is within the geographic range/distance based on the relative location of the mobile computing device as specified by the user.

### CONCLUSION

Mobile social activity networking systems and methods with geographical vicinity features based on the use of GPS has been disclosed. The system/methods include mobile computing devices (MCDs) communicating over a network. The MCDs are enabled to keep track of their geographic location through a global positioning system (GPS). Users download an activity network application (ANA) from a mobile application server (MAS) through a mobile web server (MWS). With the ANA, users choose a distance and activity criteria indicating proficiency. The application searches for users within the distance with the GPS and matches users with the activity criteria. The user can perform an action to accept the matched profile. The user sends an invitation to connect with the matched user and upon acceptance, both the users are connected. The connected users can message each other or share calendar to plan activities. Connected users and their connections with a matching interest join and participate in the event.

Although various embodiments of the present exemplary embodiment have been illustrated in the accompanying drawings and described in the foregoing Detailed Description, it will be understood that the exemplary embodiment is not limited to the embodiments disclosed, but is capable of numerous rearrangements, modifications, and substitutions without departing from the spirit of the exemplary embodiment as set forth and defined by the following claims.

What is claimed is:

1. A mobile social activity networking system configured for facilitating event planning and coordination of activities, the system configured for use on mobile computing devices comprising global positioning system receivers, the system configured to enable a system user to:
input user preferences on a mobile computing device via a downloaded social networking application on the mobile computing device, the user preferences including preferred activities of the user, a preferred geographic range of proximity to the user of other users that the user wants to communicate with;
form a group of users, the group having group members comprised of system users, the group enabled to specify data comprising group preferences including preferred activities of the group, a preferred group geographic range of proximity to the group to the other users of the system that the group wants to communicate with;
select a location for the group of users, by providing a street address or by dropping a marker onto a location on a map displayed on a user interface of the mobile computing device;
wherein the system retrieves data comprising group preferences from a server, the system retrieves GPS coordinates of mobile computing devices in communication with the system, the system determines relative locations of mobile computing devices using the retrieved GPS coordinates, the system determines an overlap of a user-supplied geographic range and the preferred group geographic range from the selected location based on data representing relative locations of the mobile computing devices and data representing the preferred group geographic range of proximity.

2. The mobile social activity networking system of claim 1 wherein, when the user travels to a new location, the system determines the user's location using the global positioning system receiver of the mobile computing device of the user, the system automatically uses the user's input geographic preferences to determine a new overlap of a new user-defined geographic range and a new group geographic range retrieved by the system.

3. The mobile social activity networking system of claim 2 wherein, when the user travels to a new location, the system determines the user's location using the global positioning system receiver of the mobile computing device of the user, the system retrieves data representing user-subscribed events associated with the group, the system receives user input data associated with the user-subscribed events, and the system transmits the user input data to the server associated with the group to update the data representing the user-subscribed events.

4. The mobile social activity networking system of claim 3, wherein the system is configured to maintain pending lists associated with the user-subscribed events, the pending lists comprising users that traveled to new locations, and the system transmits data comprising group information to the user.

5. The mobile social activity networking system of claim 1 wherein the system is further configured to:
retrieve the data comprising the group preferences from the associated server; and
filter data comprising group information based on the data comprising the group preferences, on informational data related to the user, and on geographic data related to the user.

6. The mobile social activity networking system of claim 1 wherein the system is configured to
automatically transmit messages including event invitations and event updates to members of the group, wherein members are users who are subscribed to the group.

7. A mobile social activity networking system configured for facilitating event planning and coordination of activities, the system configured for use by a plurality of users that each have a mobile computing device comprising a global positioning system receiver, wherein the system is configured to:
enable a user to use the mobile computing device to download a social activity networking application into the mobile computing device;
enable a user to communicate with a third party server to participate in planned events and coordinated activities, wherein the third party server comprises data representing group preferences, the planned events and the coordinated activities, and the third party server is associated with a group; and
enable a user to select a location for the group of users, by providing a street address or by dropping a marker onto the location on a map displayed on a user interface of the mobile computing device;
wherein the system authenticates the download and authorizes the user, based on user data input via the social networking application;
receives user input preferences including demographic data defining groups the user wants to interact with, preferred activities the user wants to engage in, the preferred geographic range of proximity to the user of groups;
retrieves GPS coordinates of the mobile computing device in communication with the system using the global positioning system receivers;
determines relative locations of the plurality of users through the mobile computing device that each of the plurality of users has, using the retrieved GPS coordinates;
determines an overlay of a user-supplied geographical area and a group geographical area from the selected location retrieved by the system from the third party server, wherein the group profile is associated the group.

8. The mobile social activity networking system of claim 7 wherein, when the user travels to a new location, the system determines the user's location using the global positioning system receiver of the mobile computing device of the user, the system automatically uses the user's input geographic preferences to determine a new overlap of a new user-defined geographic range and a new group geographic range retrieved by the system.

9. The mobile social activity networking system of claim 8 wherein, when the user travels to a new location, the system determines the user's location using the global positioning system receiver of the mobile computing device of the user, the system retrieves data representing user-subscribed events associated with the group, the system receives user input data associated with the user-subscribed events, and the system transmits the user input data to the server associated with the group to update the data representing the user-subscribed events.

10. The mobile social activity networking system of claim 9, wherein the system is configured to maintain pending lists associated with the user-subscribed events, the pending lists comprising users that traveled to new locations, and the system transmits data comprising group information to the user.

11. The mobile social activity networking system of claim 7 wherein the system is further configured to:
retrieve the data comprising the group preferences from the associated server; and
filter data comprising group information based on the data comprising the group preferences, on informational data related to the user, and on geographic data related to the user.

12. The mobile social activity networking system of claim 7 wherein the system is configured to
automatically transmit messages including event invitations and event updates to members of the group, wherein members are users who are subscribed to the group.

13. A mobile social activity networking system configured for facilitating event planning and coordination of activities between system-matched users of the system, the system configured for use by a plurality of users that each have a mobile computing device comprising a global positioning system receiver, with touch-activated graphic user interface, and with communications capability through telephony or wifi, or both,
wherein the system is configured to: enable a user to use the mobile computing device to download an activity networking application into the mobile computing device,
enable a user to communicate with a multi-group server to participate in planned events and coordinated activities, wherein the multi-group server comprises data representing group information including group preferences, a preferred group geographical area, planned events and coordinated activities and is associated with a plurality of groups;
enable the user to select a location for the group of users, by providing a street address or by dropping a marker onto the location on a map displayed on a user interface of the mobile computing device;
the system further configured to:
retrieve GPS coordinates of the mobile computing device in communication with the system using the global positioning system receiver;
determine a relative location of the mobile computing device using the retrieved GPS coordinates;
determine an overlay of a user geographical area and the preferred group geographical area for the selected location for each of the groups associated with the multi-group server;
identify in-range groups based on said overlay that conform to the user's input preferences.

14. The mobile social activity networking system of claim 13 wherein, when the user travels to a new location, the system determines the user's location using the global positioning system receiver of the mobile computing device of the user, the system automatically uses the user's input geographic preferences to determine a new overlap of a new user-defined geographic range and a new group geographic range retrieved by the system.

15. The mobile social activity networking system of claim 13 wherein, when the user travels to a new location, the system determines the user's location using the global positioning system receiver of the mobile computing device of the user, the system retrieves data representing user-subscribed events associated with the group, the system receives user input data associated with the user-subscribed events, and the system transmits the user input data to the server associated with the group to update the data representing the user-subscribed events.

16. The mobile social activity networking system of claim 15, wherein the system is configured to maintain pending lists associated with the user-subscribed events, the pending lists comprising users that traveled to new locations, and the system transmits data comprising group information to the user.

17. The mobile social activity networking system of claim 13 wherein the system is further configured to:
retrieve the data comprising the group preferences from the associated server; and
filter data comprising group information based on the data comprising the group preferences, on informational data related to the user, and on geographic data related to the user.

18. The mobile social activity networking system of claim 13 wherein the system is configured to
automatically transmit messages including event invitations and event updates to members of the group, wherein members are users who are subscribed to the group.
